(19) United States
(12) Patent Application Publication
(10) Pub. No.: US 2025/0288951 A1
(43) Pub. Date: Sep. 18, 2025

(54) CARBON DIOXIDE ADSORPTION-DESORPTION DEVICE

(71) Applicant: KABUSHIKI KAISHA TOSHIBA, Tokyo (JP)

(72) Inventor: Hitomi SAITO, Tokyo (JP)

(73) Assignee: KABUSHIKI KAISHA TOSHIBA, Tokyo (JP)

(21) Appl. No.: 19/033,747

(22) Filed: Jan. 22, 2025

(30) Foreign Application Priority Data
Mar. 18, 2024 (JP) 2024-042793

(51) Int. Cl. B01D 53/32; B01D 53/14; B01J 20/22; C25B 9/19

(52) U.S. Cl. CPC B01D 53/326; B01D 53/1475; B01J 20/226; C25B 9/19; B01D 2252/205; B01D 2257/504; B01D 2259/80

(57) ABSTRACT

According to one embodiment, provided is a carbon dioxide absorption-release device including a pair of electrodes, an aqueous electrolyte, a first electrolyte flow path, and a second electrolyte flow path. Each of the pair of electrodes include a porous composite, where the porous composite contains an electro-conductive component and a porous material on the electro-conductive component, and the porous material includes a reactive moiety for electrochemical proton transfer. In the first electrolyte flow path, one of the pair of electrodes contacts the aqueous electrolyte. In the second electrolyte flow path, the other of the pair of electrodes contacts the aqueous electrolyte.

### CROSS-REFERENCE TO RELATED APPLICATION

This application is based upon and claims the benefit of priority from prior Japanese Patent Application No. 2024-042793, filed Mar. 18, 2024, the entire contents of which are incorporated herein by reference.

### FIELD

Embodiments described herein relate generally to a carbon dioxide adsorption-desorption device.

### BACKGROUND

A technique for causing carbon dioxide to be absorbed into an absorbent such as an amine is used in a carbon dioxide capture and storage (CCS) plant such as a thermal power plant, and is regarded as a most promising candidate as a technique for global warming prevention. The absorbent that has absorbed carbon dioxide is generally heated in a regeneration tower, thereby being regenerated by releasing the carbon dioxide, and repeatedly used. A general temperature for heating at this time is about 140° C., consuming great energy. Heat and energy required for regeneration are also called heat duty or energy penalty. If this heating temperature can be lowered to efficiently release carbon dioxide, energy reduction can be achieved, allowing promotion of the spread of this technique as a technique for global warming prevention.

In addition, use of a porous material as a carbon dioxide adsorbent is also known. Since a porous material has a relatively large specific surface area, the applications such as gas storage, gas separation, catalyst, and reaction field are being considered by selecting a suitable pore size and/or an organic group with high carbon dioxide affinity to adsorb a large amount of gas or organic molecules. As porous materials, there are known zeolite, porous silica, porous alumina, porous carbon materials, metal-organic frameworks (MOF), covalent-organic frameworks (COF), porous materials obtained by modifying pores of these porous materials with amine molecules, and the like. Even when such a porous material is used, the carbon dioxide adsorbent is basically regenerated by heating, and energy saving is required similarly to an absorbent such as an amine.

As an energy-saving regeneration method, there is a method by which adsorbed carbon dioxide is substituted with water vapor. Carbon dioxide is released from the adsorbent by a substitution reaction of adsorbed carbon dioxide with water vapor. According to this method, the heating temperature can be lowered to 100° C. or lower, but water vapor is contained in the released gas in addition to carbon dioxide. Therefore, the process of cooling the released gas and condensing the water vapor, to thereby separate the water vapor from the carbon dioxide is added at a subsequent stage. Therefore, although energy saving can be achieved as compared with thermal desorption, the method can hardly be said to be optimal as a method for regenerating an absorbent.

Meanwhile, there has also been studied a technique of separating carbon dioxide by switching between electrical potentials, instead of heating, using a polymer or porous material containing electroactive groups. By using this method, carbon dioxide can be released without heating, so that the effect of energy saving can be expected.

### BRIEF DESCRIPTION OF THE DRAWINGS

FIG. 1 is a schematic cross-sectional view of a carbon dioxide absorption-release device according to an embodiment, showing an example of an operation mode.

FIG. 2 is a schematic cross-sectional view of the carbon dioxide absorption-release device according to the embodiment, showing an example of another operation mode.

FIG. 3 is a schematic cross-sectional view of an example of an electrode included in the carbon dioxide absorption-release device according to the embodiment.

FIG. 4 is a flowchart illustrating an example of operations of the carbon dioxide absorption-release device according to the embodiment.

FIG. 5 is a flowchart illustrating another example of operations of the carbon dioxide absorption-release device according to the embodiment.

FIG. 6 is a list diagram showing structural formulas of examples of a quinone-based redox-active group.

FIG. 7 is a list view showing structural formulas of examples of an N-containing redox-active group.

FIG. 8 is a list view showing structural formulas of examples of an S-containing redox-active group.

FIG. 9 is a list view showing structural formulas of examples of a fused heteroaromatic ring redox-active group.

FIG. 10 is an example of a proton transfer scheme by a quinone-based redox molecule.

FIG. 11 is an example of a proton transfer scheme by a sulfide-based redox molecule.

FIG. 12 is an example of a proton transfer scheme by a fused heteroaromatic ring redox molecule.

FIG. 13 is another example of a proton transfer scheme by a fused heteroaromatic ring redox molecule.

FIG. 14 is a graph showing a cyclic voltammetry curve measured in Example 2.

FIG. 15 is a graph showing a cyclic voltammetry curve measured in Example 5.

### DETAILED DESCRIPTION

According to one embodiment, provided is a carbon dioxide absorption-release device including a pair of electrodes, an aqueous electrolyte, a first electrolyte flow path, and a second electrolyte flow path. Each of the pair of electrodes include a porous composite, where the porous composite contains an electro-conductive component and a porous material on the electro-conductive component, and the porous material includes a reactive moiety for electrochemical proton transfer. In the first electrolyte flow path, one of the pair of electrodes contacts the aqueous electrolyte. In the second electrolyte flow path, the other of the pair of electrodes contacts the aqueous electrolyte.

Hereinafter, embodiments will be described with reference to the drawings. The same reference signs are applied to common components throughout the embodiments and overlapped explanations are thereby omitted. Each drawing is a schematic view for encouraging explanations of the embodiment and understanding thereof, and thus there are some details in which a shape, a size and a ratio are different from those in a device actually used, but they can be appropriately design-changed considering the following explanations and known technology.

Embodiments described below relate to a device and a method for separating carbon dioxide (CO₂) from a gas containing the carbon dioxide by an electrochemical pH change. The device is an electrically responsive device that efficiently recovers carbon dioxide.

The carbon dioxide adsorption-desorption device according to the embodiment includes a pair of electrodes, an aqueous electrolyte, a first electrolyte flow path, and a second electrolyte flow path. Each of the electrodes include a porous composite. The porous composite includes an electro-conductive component and a porous material having a reactive moiety that electrochemically undergoes proton transfer. The porous material is provided on the electro-conductive component. In the first electrolyte flow path, one of the pair of electrodes is in contact with the aqueous electrolyte. In the second electrolyte flow path, the other of the pair of electrodes is in contact with the aqueous electrolyte.

The carbon dioxide absorption-release device is a device that absorbs and releases carbon dioxide by changing pH in an aqueous electrolyte by electric proton transfer at electrodes to increase or decrease solubility of CO₂ in the electrolyte. With such a device that absorbs and releases carbon dioxide by electrically changing the pH, carbon dioxide can be absorbed and released at room temperature. Therefore, the device can absorb and release carbon dioxide with low energy.

Such a device can suitably absorb carbon dioxide as described above, and can be suitably applied to recovering of carbon dioxide from factory exhaust gases or the atmosphere.

According to the embodiment, there is provided a device that performs gas adsorption and release with a pH swing (electro-swing absorption-release) through proton-coupled electron transfer at electrode in an aqueous electrolyte. The aqueous electrolyte circulates through the device in such a manner that the electrolyte alternately contacts an electrode that operates as a cathode and an electrode that operates as an anode, and the pH of the aqueous electrolyte changes due to proton-coupled electron transfer at each electrode. In the aqueous electrolyte in a high pH state, the hydroxide ion (OH⁻) concentration is high, and since OH⁻ and CO₂ can react with each other, the solubility of CO₂ in the electrolyte is high. In the aqueous electrolyte in a low pH state, CO₂ is reformed and released from the electrolyte. Such an embodiment can provide a carbon dioxide absorption-release device with high operation efficiency.

Each electrode may further include a current collector ono which a porous composite is disposed. The porous composite may be supported on the current collector. For example, the porous composite may be formed on a current collector surface. Alternatively, the porous composite may be held, for example, by a mesh-shaped current collector.

The current collector can function as a conductor for achieving electrical response of reactive moieties that electrochemically perform proton transfer by transmitting charges to the porous composite. Proton transfer reactions can be caused by varying the electrical potential of the current collector to oxidize and reduce the reactive moieties contained in the porous composite.

The porous composite includes an electro-conductive component and a porous material having reactive moieties that electrochemically perform proton transfer. In the porous composite, the porous material is on a surface of the electro-conductive component. The reactive moieties that perform proton transfer may be an organic functional group whose redox state changes according to charge application, namely, a redox-active group that exhibits electrical response, for example. The reactive moieties may be contained on the surface of the porous material, for example. The surface of the porous material herein includes inner surfaces (pore wall surfaces) of the pores in addition to an outer surface on the outer periphery. The surface area can be increased by using the porous material, so that the density of the reactive moieties can be enhanced.

By including a porous material having reactive moieties that electrochemically perform proton transfer in the electrode, the use efficiency of the reactive moieties can be maximized. The proton transfer reaction by the reactive moieties is an electrochemical process, which is driven by electric power supplied from the electrode. Therefore, the electrochemical reaction can be efficiently performed by including the reactive moieties as a part of the electrode. If the reactive moieties are not supported on the electrode but are dispersed in the electrolyte as isolated molecules, for example, only molecules approaching the electrode can participate in the electrochemical reaction. Namely, the encounter rate between the electrode and the redox molecule including the reactive moieties limits the rate of the electrochemical reaction. Thus, even if the concentration of redox molecule in the liquid is increased, the reaction cannot be infinitely accelerated by the concentration increase. Therefore, the reactive moieties are included in the electrode in order to maximally utilize the redox-active reactive moieties in the device.

The electrode including the porous composite contained in the carbon dioxide adsorption-desorption device may further include a second electro-conductive component in addition to the electro-conductive component included in the porous composite. Electrical connection between porous composites can be reinforced by separately adding the second electro-conductive component in addition to the first electro-conductive component included in the porous composite. When the electrode includes a current collector, the electrical connection between the porous composite and the current collector can also be reinforced.

The electrode may further include a component that physically entangles porous composites, providing reinforcement. Examples of such a structure reinforcing component includes fibrous carbon materials, electro-conductive inorganic-organic hybrid materials, electro-conductive polymers, non-electro-conductive polymers, and ion-conductive polymers. The structure reinforcing component preferably has a shape of fine fibers advantageous for entangling the porous composites, and more preferably is electrically conductive. For providing physical reinforcement, a length of the structure reinforcing component is preferably 1 μm or more. As the structure reinforcing component, for example, carbon nanofiber, polyaniline, polythiophen, poly(3,4-ethylenedioxythiophene)-polystyrene sulfonate (PEDOT: PSS), polyvinylidene fluoride (PVdF), polymethyl methacrylate (PMMA), polyimide (PI), polyethylene oxide, polypropyl oxide, polyacrylonitrile, and polyvinyl chloride may be used. Inclusion of the structure reinforcement component also makes possible the use of the porous composite as a free-standing sheet-shaped composite electrode without a current collector. One or more component included in the electrode may serve as the structure reinforcing component.

The electrode may further include a binder. The binder may be included or not included. The binder can bind, for example, the current collector, the porous composite, and optionally the second electro-conductive component. As the binder, for example, polyvinylidene fluoride (PVdF), polymethyl methacrylate (PMMA), or polyimide (PI) may be used.

In addition, when an electrically non-conductive polymer as the binder is dispersed in a state of fine fibers among the porous composites, the binder can also provide action as the above structure reinforcing component.

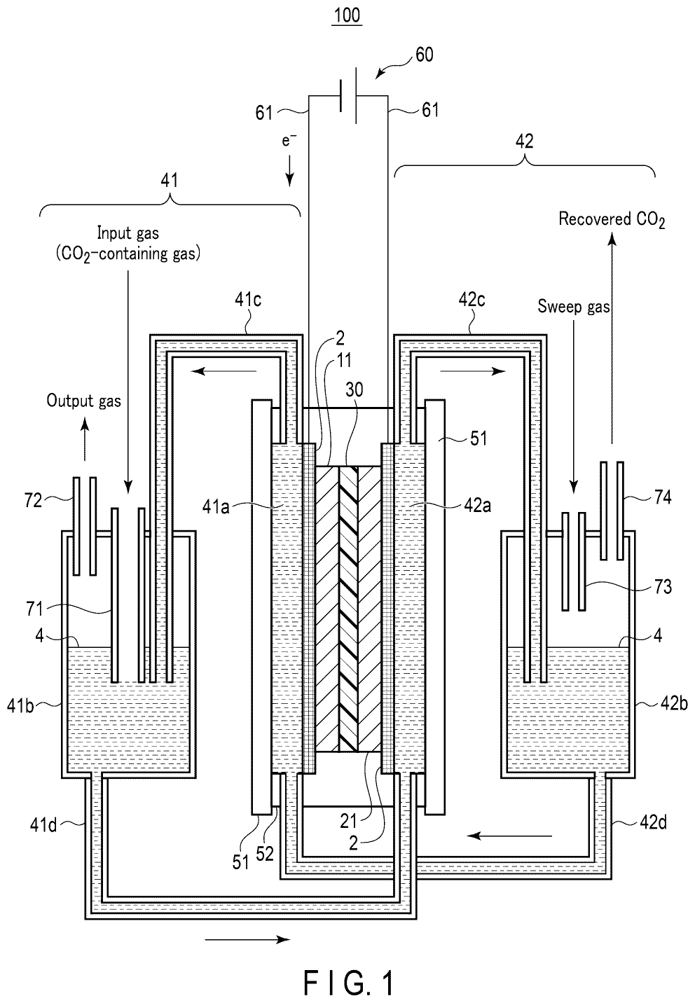

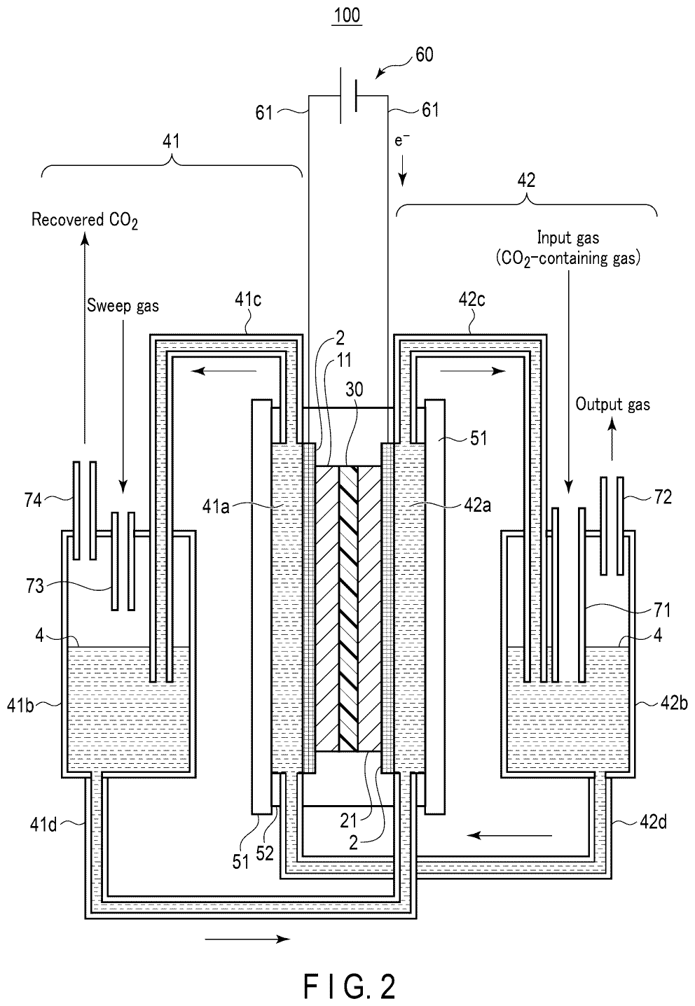

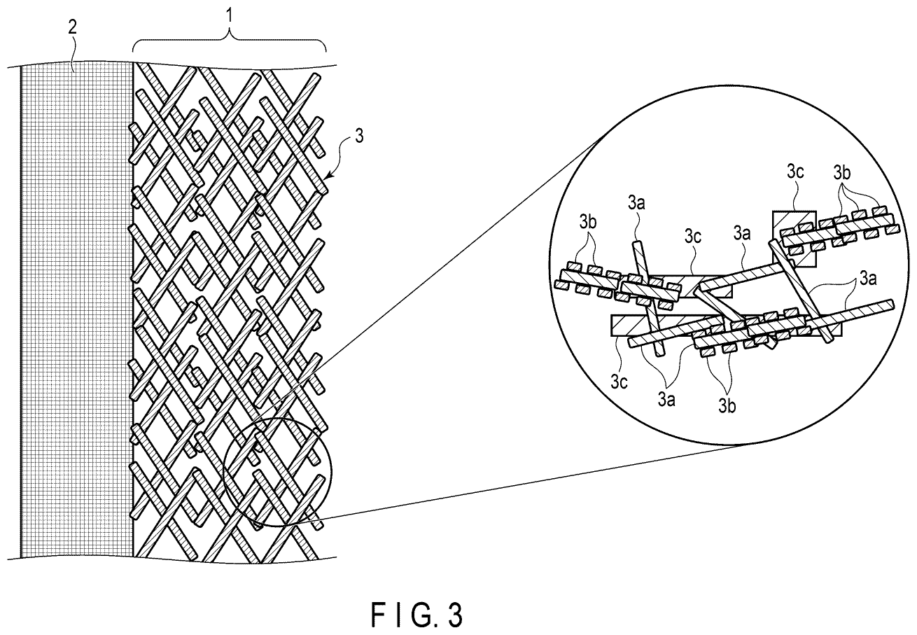

A specific example of a carbon dioxide absorption-release device according to an embodiment and operations thereof will be described with reference to the drawings. FIGS. 1 and 2 are schematic cross-sectional views of an example of the carbon dioxide absorption-release device according to the embodiment. FIG. 3 is an enlarged cross-sectional view of an example of an electrode included in the device. FIG. 1 illustrates one mode of operations of the device, and FIG. 2 illustrates another mode of operations of the device. As will be described later, it is possible to switch back and forth between the two modes by switching the current and potential applied to the electrode of the device.

A carbon dioxide absorption-release device 100 includes a pair of electrodes including a first electrode 11 and a second electrode 21, and a flow path through which an aqueous electrolyte 4 circulates within the device. In the illustrated example, the carbon dioxide absorption-release device 100 further includes a membrane 30 positioned between the first electrode 11 and the second electrode 21. The stack of the first electrode 11, the membrane 30, and the second electrode 21 is sandwiched between a pair of current collecting electrodes 2. The current collecting electrodes 2 can function as electrode leads, and each one is respectively electrically connected to each of the electrodes. The flow path for the aqueous electrolyte 4 can be roughly divided into a first electrolyte flow path 41 and a second electrolyte flow path 42. The aqueous electrolyte 4 flowing through the first electrolyte flow path 41 can contact the first electrode 11 in at least a part of the first electrolyte flow path 41. The aqueous electrolyte 4 flowing through the second electrolyte flow path 42 can contact the second electrode 21 in at least a part of the second electrolyte flow path 42. The carbon dioxide absorption-release device 100 may include support plates 51 and a support member 52 that configure a housing that houses the first electrode 11, the second electrode 21, and the membrane 30 and houses or defines at least a part of the first electrolyte flow path 41 and at least a part of the second electrolyte flow path 42, for example. While a flow path through which the aqueous electrolyte 4 can circulate and flow so as to alternately contact the first electrode 11 and the second electrode 21 should be constructed, the housing (the support plates 51, the support member 52, and the like) may be omitted, for example. The first electrode 11 and the second electrode 21 are electrically connected to a power supply 60 as a power source for electrochemically operating the device via the current collecting electrodes 2 and wiring 61, for example.

The first electrode 11 includes a first porous composite. Similarly, the second electrode 21 includes a second porous composite. The first electrode 11 and the second electrode 21 may have a structure shown in FIG. 3, for example. An electrode 1 collectively representing the first electrode 11 and the second electrode 21 will be exemplified. The electrode 1 includes a porous composite 3. In the figure, the current collecting electrode 2 adjacent to the electrode 1 in the device is also shown. In the illustrated example, the electrode 1 consists of the porous composite 3 without including a current collector. However, the electrode 1 may further include a current collector as a substrate onto which the porous composite 3 is provided. The porous composite 3 may be provided on one surface of the current collector, or the porous composite 3 may be provided on a plurality of surfaces of the current collector. Alternatively, the porous composite 3 may intrude inside the current collector instead of being provided on the flat plate surface, for example. The current collecting electrode 2 with a plate-shaped network structure is in contact with one principal surface of the porous composite 3 of the electrode 1, and is thereby electrically connected to the electrode 1. The current collecting electrode 2 desirably does not inhibit the flow of the aqueous electrolyte, and may be a member with a network structure having electrical conductivity such as a stainless steel mesh, for example.

As in an enlarged view of the porous composite 3 in FIG. 3, the porous composite 3 includes electro-conductive components 3a, porous materials 3b, and binders 3c. The porous materials 3b are found on the electro-conductive components 3a. The binders 3c bind the electro-conductive components 3a to each other. The binders 3c may be omitted.

Although no example is shown, the carbon dioxide absorption-release device 100 may further include a reference electrode in addition to the pair of electrodes (the first electrode 11 and the second electrode 21). The location of the reference electrode is not particularly limited as long as the reference electrode is in contact with the aqueous electrolyte 4.

The membrane 30 separates the first electrode 11 and the second electrode 21. As the membrane 30, there may be used a membrane that can selectively permeate any of cations and anions. The membrane 30 may include an ion-exchange membrane, such as an anion-exchange membrane, for example. In the illustrated example, the membrane 30 is stacked together with the electrodes so as to be sandwiched between the first electrode 11 and the second electrode 21. So long as the position of the membrane 30 is between the first electrode 11 and the second electrode 21 within the device, the membrane 30 need not be in contact with each electrode. For example, the first electrode 11 and the second electrode 21 may be arranged along the support plates 51 of the housing while the membrane 30 is kept at the center in FIGS. 1 and 2. In addition, instead of using the membrane 30, a first proton transfer reaction chamber 41a in which the first electrode 11 is located and a second proton transfer reaction chamber 42a in which the second electrode 21 is located may be housed in individual housings, and the reaction chambers may be connected to each other by a salt bridge. The first electrode 11, the membrane 30, and the second electrode 21 are preferably stacked from the viewpoint of shortening the electric circuit and reducing various resistances in order to enhance the operation efficiency.

The first electrolyte flow path 41 includes at least the first proton transfer reaction chamber 41a inside which the aqueous electrolyte 4 contacts the first electrode 11. In the illustrated example, the first electrolyte flow path 41 further includes a first tank 41b in which carbon dioxide is absorbed and released by the aqueous electrolyte, a connection pipe 41c that connects the first proton transfer reaction chamber 41a and the first tank 41b, and a connection pipe 41d that feeds the aqueous electrolyte 4 from the first tank 41b to the second electrolyte flow path 42. The exemplified first proton transfer reaction chamber 41a is partially defined by the support plate 51 and the support member 52.

Similarly, the second electrolyte flow path 42 includes at least the second proton transfer reaction chamber 42a inside which the aqueous electrolyte 4 contacts the second electrode 21. In the illustrated example, the second electrolyte flow path 42 further includes a second tank 42b in which carbon dioxide is absorbed and released by the aqueous electrolyte 4, a connection pipe 42c that connects the second proton transfer reaction chamber 42a and the second tank 42b, and a connection pipe 42d that feeds the aqueous electrolyte 4 from the second tank 42b to the first electrolyte flow path 41. The exemplified second proton transfer reaction chamber 42a is partially defined by the support plate 51 and the support member 52.

In the first proton transfer reaction chamber 41a and the second proton transfer reaction chamber 42a, a proton transfer reaction occurs between the aqueous electrolyte 4 and reactive moieties of the porous materials 3b included in the first porous composite and the second porous composite. In one operation mode of the device, the reactive moieties accept protons from the aqueous electrolyte 4 at one electrode, and the reactive moieties donate protons to the aqueous electrolyte 4 at the other electrode. In another operation mode, whether protons are accepted or donated is swapped between the pair of electrodes. In the mode shown in FIG. 1, protons bind to the reactive moieties in the first electrode 11, and protons become dissociated from the reactive moieties in the second electrode 21. In the mode shown in FIG. 2, conversely, protons become dissociated from the reactive moieties in the first electrode 11, and protons bind to the reactive moieties in the second electrode 21.

In the first tank 41b and the second tank 42b, CO₂ is absorbed into the aqueous electrolyte 4 or CO₂ is released from the aqueous electrolyte 4. In one operation mode of the device, CO₂ is absorbed in one tank and CO₂ is released in the other tank. In another operating mode, whether CO₂ absorption or CO₂ release takes place is swapped between the two tanks. In the mode shown in FIG. 1, CO₂ is absorbed by the aqueous electrolyte 4 in the first tank 41b, and CO₂ is released from the aqueous electrolyte 4 in the second tank 42b. In the mode illustrated in FIG. 2, conversely, CO₂ is released from the aqueous electrolyte 4 in the first tank 41b, and CO₂ is absorbed by the aqueous electrolyte 4 in the second tank 42b.

The first tank 41b and the second tank 42b are each provided with a CO₂-containing gas introduction pipe 71 and a gas discharge pipe 72, a sweep gas introduction pipe 73 and a CO₂ recovery pipe 74. The ventilation paths of these ventilation pipes can be shut and opened according to the operation mode of the device, by opening and closing of valves or mechanical insertion and retraction of pipes, for example. For simplification of the drawing, FIGS. 1 and 2 show only the ventilation pipes establishing ventilation to the first tank 41b and the second tank 42b in the corresponding operation modes, and do not show shut-off ventilation pipes.

As in the illustrated example, the installation locations of the electrodes where the electrochemical proton transfer reaction occurs (the first proton transfer reaction chamber 41a and the second proton transfer reaction chamber 42a) are desirably separated from locations where gas including CO₂ is introduced and recovered (the first tank 41b and the second tank 42b). By separating the installation locations, the influence of drying or fouling of the electrodes due to direct flow of gas over the electrode surfaces can be avoided.

In each of the first electrolyte flow path 41 and second electrolyte flow path 42, for example, a pump (not shown) may be installed for the flow of the aqueous electrolyte 4. The installation positions of the pumps are not particularly limited, so long as a design is adopted, in which the aqueous electrolyte 4 can be circulated so as to alternately flow through the first electrolyte flow path 41 and the second electrolyte flow path 42. Further, the pathways of the first electrolyte flow path 41 and the second electrolyte flow path 42 are not limited to those shown in the drawings. For example, instead of flowing the aqueous electrolyte by the pump in a part of the electrolyte flow path, the aqueous electrolyte may be flown by using gravity.

The operation modes of the carbon dioxide absorption-release device 100 shown in FIGS. 1 and 2 will be described in detail. In the mode shown in FIG. 1, the first electrode 11 is operated as a cathode, and the second electrode 21 is operated as an anode. In contrast, in the mode shown in FIG. 2, the first electrode 11 is operated as an anode, and the second electrode 21 is operated as a cathode.

The operation mode shown in FIG. 1 may be a mode starting in the device in the state described below, for example. The mode of FIG. 1 is desirably started from a state in which, most or all of the reactive moieties of the porous material in the first electrode 11 take oxidized forms that have not had accepted protons, and most or all of the reactive moieties of the porous material in the second electrode 21 take reduced forms that are protonated forms. A reduction current or a reduction potential is applied from the power supply 60 to the first electrode 11 operating as a cathode installed in the first proton transfer reaction chamber 41a, and electrons (e⁻) are supplied to the reactive moieties in the first electrode 11. In addition, an oxidation current or an oxidation potential is applied from the power supply 60 to the second electrode 21 that operates as an anode installed in the second proton transfer reaction chamber 42a.

The reactive moieties of the first porous composite included in the first electrode 11 are reduced by the reduction current or the reduction potential, and the reactive moieties now in the reduced state reacts with the water (H₂O) in the aqueous electrolyte 4 in the first proton transfer reaction chamber 41a. In the reaction, the reactive moieties each receive one proton (H⁺) from H₂O, and OH⁻ is generate at the same time. The following reaction formula 1 represents a proton transfer reaction at the cathode electrode. In the reaction formula, Rx represents an oxidized form of a reactive moiety for proton transfer, and Rx(H) represents a protonated form in which a proton is bonded to the reactive moiety, namely, a reduced form.

Rx+H₂O+e⁻→Rx(H)+OH⁻ 1

Since H₂O molecules contained in the aqueous electrolyte 4 in contact with the first electrode 11 as a cathode are oxidized to generate OH⁻, the pH of the aqueous electrolyte 4 in the first proton transfer reaction chamber 41a increases to yield an alkaline aqueous solution. For example, the increased pH could be about 10. The aqueous electrolyte 4 increased in pH flows from the first proton transfer reaction chamber 41a to the first tank 41b through the connection pipe 41c.

A gas containing CO₂, for example, a gas to be treated such as a factory exhaust gas is introduced into the first tank 41b through the CO₂-containing gas introduction pipe 71. When a CO₂-containing gas is exposed to the aqueous electrolyte 4 having a high pH, bicarbonate ions (HCO₃⁻) are generated by the reaction between OH⁻ and CO₂ represented by the following reaction formula 2a, and carbonate ions (CO₃²⁻) are further formed by the reaction between OH⁻ and HCO₃⁻ represented by the following reaction formula 2b. Since CO₂ can be dissolved in the form of HCO₃⁻ or CO₃²⁻, the solubility of CO₂ in the aqueous electrolyte 4 having a high pH is high. Therefore, the CO₂ in the CO₂-containing gas introduced from the CO₂-containing gas introduction pipe 71 into the first tank 41b is absorbed by the aqueous electrolyte 4. The pH of the aqueous electrolyte 4 slightly decreases due to consumption of OH⁻, and the aqueous electrolyte 4 approaches neutrality.

OH+CO₂→HCO₃⁻ 2a

HCO₃⁻+OH⁻→CO₃²⁻+H₂O 2b

The aqueous electrolyte 4 that has absorbed CO₂ in the form of HCO₃⁻ or CO₃²⁻ flows from the first tank 41b to the second electrolyte flow path 42, specifically, the second proton transfer reaction chamber 42a, through the connection pipe 41d that feeds the aqueous electrolyte 4.

In the second proton transfer reaction chamber 42a, the reduced forms (Rx(H)) of the reactive moieties contained in the second porous composite in the second electrode operating as an anode are oxidized, and react with HCO₃⁻ and CO₃²⁻ contained in the aqueous electrolyte 4 supplied from the first tank 41b. CO₂ and H₂O are produced by the reaction. In addition, since protons are dissociated from the protonated reactive moieties (Rx(H)) and are donated to HCO₃⁻ and CO₃²⁻, the reactive moieties in the second electrode 21 take oxidized forms (Rx) that do not have protons accepted thereto. The following reaction formulas 3a and 3b represent proton transfer reactions at the anode electrode.

Rx(H)+HCO₃⁻→Rx+H₂O+CO₂+e⁻ 3a

2Rx(H)+CO₃²⁻→2Rx+H₂O+CO₂+2e⁻ 3b

Protons are donated from the reactive moieties to the aqueous electrolyte 4 by the proton transfer reaction at the second electrode 21, and the pH of the aqueous electrolyte 4 decreases. For example, the decreased pH could be about 6. The proton donation to the aqueous electrolyte 4 can include a hydronium ion (H₃O⁺) generation reaction represented by the following reaction formula 4, a reaction between HCO₃⁻ and H₃O⁺ and a reaction between CO₃²⁻ and H₃O⁺ represented by the following reaction formula 5a and reaction formula 5b, respectively, for example. The reaction formula 3a and the reaction formula 3b can be said to be a combination of the H₃O⁺ generation reaction in the reaction formula 4 with the reaction formula 5a and the reaction formula 5b for generating CO₂ and H₂O, respectively.

Rx(H)+H₂O→Rx+H₃O⁺+e⁻ 4

HCO₃⁻+H₃O⁺→2H₂O+CO₂ 5a

CO₃²⁻+2H₃O⁺→3H₂O+CO₂ 5b

The solubility of CO₂ in the aqueous electrolyte 4 having a decreased pH is low, and CO₂ that had been dissolved as HCO₃⁻ or CO₃²⁻ is released. For example, the CO₂ is released from the liquid phase by the time the aqueous electrolyte 4 reaches the second tank 42b through the connection pipe 42c, and can be recovered from the CO₂ recovery pipe 74. Through the sweep gas introduction pipe 73, an inert gas such as nitrogen (N₂) or a pure CO₂ gas is introduced as a sweep gas, for example.

The aqueous electrolyte 4 that has released CO₂ flows from the second tank 42b to the first electrolyte flow path 41, specifically, the first proton transfer reaction chamber 41a, through the connection pipe 42d that feeds the aqueous electrolyte 4. The aqueous electrolyte 4 can contact the first electrode 11 again, and the proton transfer reaction occurs again between the reactive moieties of the first porous composite and H₂O.

As described above, in the operation mode illustrated in FIG. 1, the aqueous electrolyte 4 circulates within the carbon dioxide absorption-release device 100, thereby repeating OH-generation (oxidation of H₂O) in the first proton transfer reaction chamber 41a, CO₂ absorption in the first tank 41b, H₂O regeneration (reduction to H₂O) in the second proton transfer reaction chamber 42a, and CO₂ release in the second tank 42b. As the pH of the aqueous electrolyte 4 traveling back and forth between the first electrolyte flow path 41 and the second electrolyte flow path 42 changes, the solubility of CO₂ in the aqueous electrolyte 4 when the aqueous electrolyte 4 enters the first tank 41b is high, and the solubility of CO₂ in the aqueous electrolyte 4 when the aqueous electrolyte 4 enters the second tank 42b is low. Therefore, CO₂ can be absorbed from the gas to be treated in the first tank 41b in the first electrolyte flow path 41, and the captured CO₂ can be recovered from the second tank 42b in the second electrolyte flow path 42.

When the carbon dioxide absorption-release device 100 is continuously operated, a proton transfer reaction by reactive moieties electrochemically transferring protons proceeds at each electrode. In the cathode electrode, protons bind to the reactive moieties, and the reactive moieties contained in the porous composite 3 are converted into reduced forms (Rx(H)). In the anode electrode, protons are removed from the protonated forms of the reactive moieties, and the reactive moieties contained in the porous composite 3 are converted into oxidized forms (Rx). When all the reactive moieties contained in the porous composite 3 in the cathode electrode become the reduced forms (Rx(H)) or all the reactive moieties contained in the porous composite 3 in the anode electrode become the oxidized forms (Rx), the proton transfer reaction stops at that electrode, so that the absorption and release of CO₂ no longer proceed.

When the carbon dioxide absorption-release device 100 is continuously operated in the mode in which the first electrode 11 is operated as a cathode and the second electrode 21 is operated as an anode as shown in FIG. 1, the absorption and release of CO₂ by the device no longer proceed once all the reactive moieties of the first porous composite become the reduced forms (Rx(H)) in the first electrode 11 or all the reactive moieties of the second porous composite become the oxidized forms (Rx) in the second electrode 21. Then, the operation of the device is switched to the operation mode shown in FIG. 2.

Specifically, the reduction current and the oxidation current applied from the power supply 60 or the reduction potential and the oxidation potential applied from the power supply 60 are switched between the first electrode 11 and the second electrode 21, and the first electrode 11 is operated as an anode and the second electrode 21 is operated as a cathode. In addition, the ventilation paths of the ventilation pipes (CO₂-containing gas introduction pipe 71, gas discharge pipe 72, sweep gas introduction pipe 73, and CO₂ recovery pipe 74) in the first tank 41b and the second tank 42b are switched to a state in which the ventilation pipes illustrated in FIG. 2 are ventilated and the ventilation pipes not illustrated are shut.

The operation mode shown in FIG. 2 may be a mode starting in the device in the state described below, for example. The mode of FIG. 2 is desirably started from a state in which most or all of the reactive moieties of the porous material in the first electrode 11 take reduced forms and most or all of the reactive moieties of the porous material in the second electrode 21 take oxidized forms. The operation mode of FIG. 2 may be a mode after changing from the operation mode of FIG. 1 by switching the reduction current and the oxidation current or switching the reduction potential and the oxidation potential between the first electrode 11 and the second electrode 21. An oxidation current or an oxidation potential is applied from the power supply 60 to the first electrode 11 that operates as an anode installed in the first proton transfer reaction chamber 41a. A reduction current or a reduction potential is applied from the power supply 60 to the second electrode 21 that operates as a cathode installed in the second proton transfer reaction chamber 42a, and electrons (e⁻) are supplied to the reactive moieties in the second electrode 21.

The reactive moieties of the second porous composite included in the second electrode 21 are reduced by the reduction current or the reduction potential, and OH⁻ is generated by the proton transfer reaction represented by the reaction formula 1 in the second proton transfer reaction chamber 42a. Accordingly, the pH in the second proton transfer reaction chamber 42a increases to form an alkaline aqueous solution. The aqueous electrolyte 4 increased in pH flows from the second proton transfer reaction chamber 42a to the second tank 42b through the connection pipe 42c.

A gas containing CO₂ is introduced into the second tank 42b from the CO₂-containing gas introduction pipe 71. CO₂ is dissolved in the aqueous electrolyte 4 in the form of HCO₃⁻ or CO₃²⁻ by the reactions represented by the reaction formulas 2a and 2b, whereby CO₂ is absorbed in the aqueous electrolyte 4 in the second tank 42b.

The aqueous electrolyte 4 that has absorbed CO₂ in the form of HCO₃⁻ or CO₃²⁻ flows from the second tank 42b to the first electrolyte flow path 41, specifically, the first proton transfer reaction chamber 41a through the connection pipe 42d that feeds the aqueous electrolyte 4.

In the first proton transfer reaction chamber 41a, the reduced forms (Rx(H)) of the reactive moieties contained in the first porous composite are oxidized, and react with HCO₃⁻ and CO₃²⁻ contained in the aqueous electrolyte 4 supplied from the second tank 42b as represented in the reaction formulas 3a and 3b. The pH of the aqueous electrolyte 4 decreases due to the proton transfer reaction at the first electrode 11, and the solubility of CO₂ in the aqueous electrolyte 4 decreases, so that the CO₂ that had been dissolved is released. For example, the released CO₂ is released from the liquid phase by the time the aqueous electrolyte 4 reaches the first tank 41b through the connection pipe 41c, and can be recovered from the CO₂ recovery pipe 74.

The aqueous electrolyte 4 that has released CO₂ flows from the first tank 41b to the second electrolyte flow path 42, specifically, the second proton transfer reaction chamber 42a, through the connection pipe 41d that feeds the aqueous electrolyte 4. The aqueous electrolyte 4 can contact the second electrode 21 again, and the proton transfer reaction occurs again between H₂O and the reactive moieties of the second porous composite.

As described above, in the operation mode shown in FIG. 2, the roles of the first electrolyte flow path 41 and the second electrolyte flow path 42 are exchanged from those in the operation mode in FIG. 1. In the operation mode illustrated in FIG. 2, the aqueous electrolyte 4 circulates within the carbon dioxide absorption-release device 100, thereby repeating OH-generation (oxidation of H₂O) in the second proton transfer reaction chamber 42a, CO₂ absorption in the second tank 42b, H₂O regeneration (reduction to H₂O) in the first proton transfer reaction chamber 41a, and CO₂ release in the first tank 41b. As the pH of the aqueous electrolyte 4 traveling back and forth between the second electrolyte flow path 42 and the first electrolyte flow path 41 changes, the solubility of CO₂ in the aqueous electrolyte 4 when the aqueous electrolyte 4 enters the second tank 42b is high, and the solubility of CO₂ in the aqueous electrolyte 4 when the aqueous electrolyte 4 enters the first tank 41b is low. Therefore, CO₂ can be absorbed from the gas to be treated in the second tank 42b in the second electrolyte flow path 42, and the captured CO₂ can be recovered from the first tank 41b in the first electrolyte flow path 41. Although some details are omitted in the description of the mode of FIG. 2, the details are the same as those of the mode of FIG. 1 except that the first electrolyte flow path 41 side and the second electrolyte flow path 42 side are reversed.

When the carbon dioxide absorption-release device 100 is continuously operated in the mode in which the first electrode 11 is operated as an anode and the second electrode 21 is operated as a cathode as shown in FIG. 2, the absorption and release of CO₂ by the device no longer proceed once all the reactive moieties of the first porous composite become the oxidized forms (Rx) in the first electrode 11 or all the reactive moieties of the second porous composite become the reduced forms (Rx(H)) in the second electrode 21. Then, the operation of the device is switched to the operation mode shown in FIG. 1.

Specifically, the reduction current and the oxidation current or the reduction potential and the oxidation potential applied from the power supply 60 are switched between the first electrode 11 and the second electrode 21, and the first electrode 11 is operated as a cathode and the second electrode 21 is operated as an anode. In addition, the ventilation paths of the ventilation pipes (CO₂-containing gas introduction pipe 71, gas discharge pipe 72, sweep gas introduction pipe 73, and CO₂ recovery pipe 74) in the first tank 41b and the second tank 42b are switched to a state in which the ventilation pipes illustrated in FIG. 1 are ventilated and the ventilation pipes not illustrated are shut.

As described above, by configuring the carbon dioxide absorption-release device 100 capable of switching the reduction current and the oxidation current or switching the reduction potential and the oxidation potential between the first electrode 11 and the second electrode 21, recovery of CO₂ can be continuously performed by alternately repeating the operation modes illustrated in FIGS. 1 and 2.

During operation of the carbon dioxide absorption-release device 100, a constant current is applied from the power supply 60, for example. When all the reactive moieties contained in the porous composite 3 in the electrode 1 of at least one of the cathode and the anode take the reduced forms (Rx(H)) or the oxidized forms (Rx) as described above, the electrochemical proton transfer reaction no longer proceeds. Therefore, if the device is operated under the constant current condition, the current flowing through the electrode 1 decreases as the proton transfer reaction no longer proceeds, and the voltage increases due to attempting to recover the current. Therefore, an increase in voltage can be used to detect that the reactive moieties of the porous composite 3 have completely reacted in the electrode 1. For example, device control may be adopted under which switching of the reduction current and the oxidation current takes place when a rise in voltage is observed. Although not shown, the carbon dioxide absorption-release device 100 may include a voltmeter for measuring the voltage between the first electrode 11 and the second electrode 21.

Alternatively, during operation of the carbon dioxide absorption-release device 100, a constant voltage is applied from the power supply 60, for example. Similarly in the case where the device is operated under the constant voltage condition, the current flowing through the electrode 1 decreases as the proton transfer reaction stops proceeding, so that decrease in current is observed. Therefore, a decrease in current can be used to detect that the reactive moieties of the porous composite 3 have completely reacted in the electrode 1. For example, device control may be adopted under which switching of the reduction potential and the oxidation potential takes place when a decrease in current is observed. Although not shown, in order to measure the current flowing through each of the first electrode 11 and the second electrode 21, the carbon dioxide absorption-release device 100 may include a current meter such as an ammeter or a clamp meter.

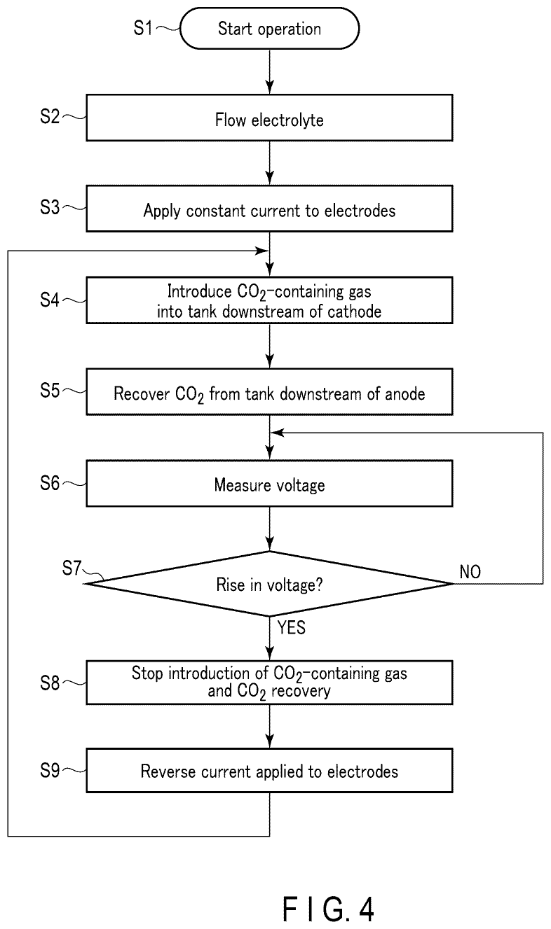

An example of operations of the carbon dioxide absorption-release device according to the embodiment illustrated in FIGS. 1 and 2 can be summarized in the flowchart shown in FIG. 4.

Operation of the carbon dioxide absorption-release device is started (S1), the electrolyte in the device is begun to flow (S2), and a constant current is begun to be applied to the pair of electrodes (S3). Of the pair of electrodes, a reduction current is applied to one electrode so as to operate as a cathode. An oxidation current is applied to the other electrode so as to operate as an anode. In the electrode operating as a cathode, the oxidized forms of the reactive moieties contained in the porous composite in the electrode are reduced and OH⁻ is generated, as represented by the reaction formula 1 described above. A CO₂-containing gas is introduced into the tank located downstream of the cathode electrode in the flow path of the electrolyte (S4). In the tank, CO₂ in the introduced gas reacts with OH⁻ in the electrolyte flowing from the cathode as represented by the reaction formulas 2a and 2b, and is dissolved in the electrolyte as HCO₃⁻ or CO₃²⁻. The electrolyte containing HCO₃⁻ or CO₃²⁻ is flown toward the electrode operating as an anode, and in the anode, as represented by the reaction formulas 3a and 3b shown above, the reduced forms of the reactive moieties contained in the porous composite within the electrode are oxidized while CO₂ is generated and released from the electrolyte. The released CO₂ is recovered in the tank located downstream of the anode (S5).

While the carbon dioxide absorption-release device is operated, voltage measurement is performed continuously or intermittently (S6). Determination is made as to whether a rise in voltage is seen or not (S7), and if there is no voltage rise, the device continues to be operated without changing the operation mode (return to S6). The voltage measurement is repeated keeping the device operating until a voltage rise is observed. When a voltage rise is detected, the operation mode is switched (proceed to S8). The introduction of the CO₂-containing gas and the CO₂ recovery are temporarily stopped in the tanks downstream of the electrodes (S8). The current applied to the electrodes is reversed such that an oxidation current is applied to the electrode that had been operating as a cathode due to application of reduction current so as to switch to the operation as an anode, and a reduction current is applied to the electrode that had been operating as an anode due to application of oxidation current so as to switch to the operation as a cathode (S9). In the state in which the operation mode is switched as described above, the introduction of the CO₂-containing gas into the tank downstream of the cathode (S4) and the CO₂ recovery from the tank downstream of the anode (S5) are resumed.

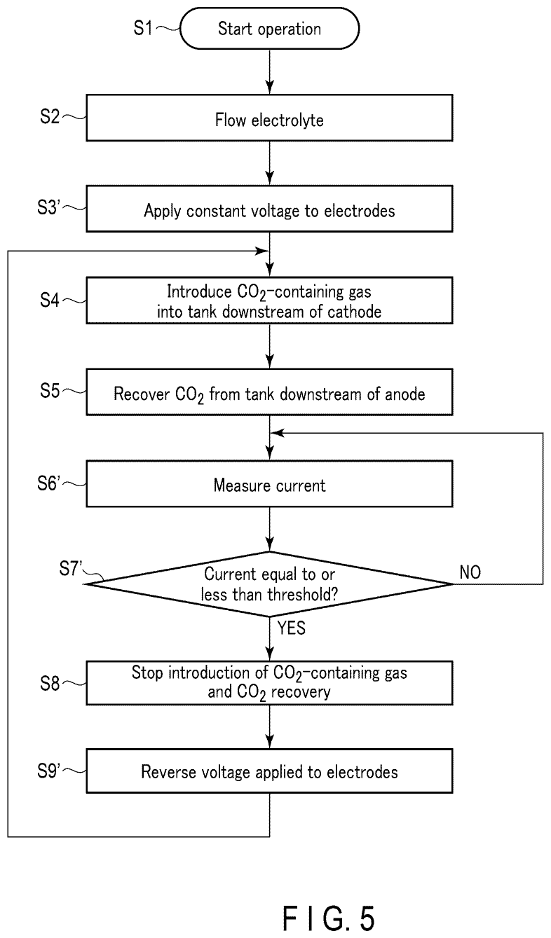

Another example of operations of the carbon dioxide absorption-release device can be summarized in the flowchart shown in FIG. 5.

Operation of the carbon dioxide absorption-release device is started (S1), the electrolyte in the device is begun to flow (S2), and a constant voltage is begun to be applied to the pair of electrodes (S3′). Of the pair of electrodes, a reduction potential is applied to one electrode so as to operate as a cathode. An oxidation potential is applied to the other electrode so as to operate as an anode. As in the former example, the oxidized forms of the reactive moieties contained in the porous composite in the cathode is reduced and OH⁻ is generated. A CO₂-containing gas is introduced into the tank downstream of the cathode (S4). In the tank, CO₂ in the introduced gas is dissolved in the electrolyte as HCO₃⁻ or CO₃²⁻. The electrolyte containing HCO₃⁻ or CO₃²⁻ is flown toward the anode, and in the anode, the reduced forms of the reactive moieties contained in the porous composite are oxidized while CO₂ is generated and released from the electrolyte. The released CO₂ is recovered in the tank located downstream of the anode (S5).

While the carbon dioxide absorption-release device is operated, current measurement is performed continuously or intermittently (S6′). Determination is made as to whether the current has decreased to a predetermined threshold or less (S7′), and if the current value exceeds the threshold, the device continues to be operated without changing the operation mode (return to S6′). The current measurement is repeated while the device is kept operating, until a current equal to or below the threshold is observed. When a current equal to or less than the threshold is detected, the operation mode is switched (proceed to S8). The introduction of the CO₂-containing gas and the CO₂ recovery are temporarily stopped in the tanks downstream of the electrodes (S8). The voltage applied between the electrodes is reversed such that an oxidation potential is applied to the electrode that had been operating as a cathode due to application of reduction potential so as to switch to the operation as an anode, and a reduction potential is applied to the electrode that had been operating as an anode due to application of oxidation potential so as to switch to the operation as a cathode (S9′). In the state in which the operation mode is switched as described above, the introduction of the CO₂-containing gas into the tank downstream of the cathode (S4) and the CO₂ recovery from the tank downstream of the anode (S5) are resumed.

When a voltage increase is detected by voltage measurement, switching of the operation mode of reversing the reduction current and the oxidation current is performed, and the device is continued to be operated. Alternatively, when a current drop is detected by current measurement, switching of the operation mode of reversing the reduction potential and the oxidation potential is performed, and the device is continued to be operated. In this way, the carbon dioxide absorption-release device can continue to be operated for a long period of time by repeating the operation of recovering CO₂ by absorption and release into and from the electrolyte and the switching of the operation mode.

Of the pair of electrodes included in the carbon dioxide absorption-release device, one electrode operates as a cathode and the other electrode operates as an anode according to the operation mode. When the operation mode is switched, the role of the cathode and the role of the anode are exchanged between the electrodes. In the electrode operating as the cathode, the pH of the aqueous electrolyte increases due to generation of OH⁻ by the proton transfer reaction, and the solubility of CO₂ increases. In the electrode operating as the anode, the pH of the aqueous electrolyte decreases due to the proton transfer reaction, and the solubility of CO₂ decreases. Namely, the carbon dioxide absorption-release device can simultaneously absorb and release CO₂ in any operation mode. Since CO₂ absorption and release do not occur alternately but rather both occur simultaneously, efficient CO₂ absorption and release is possible.

The concentration of the carbon dioxide to be introduced into the device is not particularly limited, but may correspond to a wide range of CO₂ concentrations from an atmospheric level to a level of exhausts from a thermal power plant or the like. Specifically, the concentration of the carbon dioxide is preferably 0.01 vol % or more to 50 vol % or less, and more preferably 0.04 vol % or more to 50 vol % or less.

The environmental temperature at the time of the carbon dioxide absorption and release treatment is usually preferably 10° C. or more to 60° C. or less. The temperature is more preferably 50° C. or lower, and particularly preferably 20° C. or more to 45° C. or less. The solubility of carbon dioxide increases at a lower temperature. The lower limit value of the treatment temperature can be determined by the processing gas temperature, the heat recovery goal, and the like. A tank from which carbon dioxide is introduced may be pressurized in order to increase solubility of carbon dioxide, but from the viewpoint of suppressing energy consumption required for compression, the treatment is preferably performed under atmospheric pressure.

Hereinafter, the current collector, the electro-conductive component, the porous material, and the aqueous electrolyte will be described in detail.

### (Current Collector)

As the current collector, a component made of carbon or metal may be used. The better the electrical conductivity of the current collector and larger its surface area, more charges can be transferred to the reactive moieties performing proton transfer. Examples of carbon components include glassy carbon, a graphite sheet, carbon felt, carbon cloth, a carbon mesh, carbon paper, and a carbon sheet with a gas diffusion layer. Examples of metal components include a copper plate, a copper sheet, a copper mesh, an aluminum plate, an aluminum sheet, an aluminum mesh, a nickel plate, a nickel sheet, a nickel mesh, a titanium plate, a titanium sheet, and a titanium mesh. The carbon and metal components are not limited to the above.

### (Electro-Conductive Component)

For the electro-conductive component (first electro-conductive component) of the porous composite, for example, a carbon material having good electrical conductivity may be used. Examples of the first electro-conductive component include, for example, one or more selected from the group consisting of carbon nanotube, graphite, graphene, carbon nanofiber, and Ketjen black. The shape of the first electro-conductive component is preferably linear or flat in order to increase the contact probability, and is preferably a rod shape, a tubular shape, a fiber shape, a sheet shape, or a flake shape. By disposing the porous material onto the first electro-conductive component of such a shape with a large specific surface area, an increase in the specific surface area of the porous material can be expected. The first electro-conductive component may be one species or may be a mixture of plural species.

For the second electro-conductive component outside the porous composite, for example, a carbon material having good electrical conductivity such as carbon nanotube, graphite, graphene, carbon nanofiber, carbon fiber, or Ketjen black, or a polymeric material with good electrical conductivity such as polyaniline, polythiophen, poly(3,4-ethylenedioxythiophene)-polystyrene sulfonate (PEDOT: PSS) may be used. The second electro-conductive component preferably has a shape that easily enters into a small gap. Therefore, rather than a fibrous carbon material, a tubular or particulate carbon material having a longest dimension of about several μm is more preferable as the second electro-conductive component. The second electro-conductive component may be one species or may be a mixture of plural species. The same electro-conductive component as the first electro-conductive component may be used as the second conductive component.

The above electro-conductive component includes components that can serve as the above-mentioned structure reinforcing component that physically reinforces the porous composite. The shape of the electro-conductive component that also acts as the structure reinforcing component is preferably a fine fiber shape of few nanometers to few hundred nanometers in diameter and few micrometers to few tens of micrometers in length, so as to efficiently intermingle with the porous composite. For example, an electro-conductive material of 1 μm or more in length as the electro-conductive component can entangle the porous composite to provide physical reinforcement. Such an electro-conductive material may have a length of 20 μm or less. The diameter of such an electro-conductive material is preferably 200 nm to 800 nm. As the electro-conductive component that can physically reinforce the porous composite, for example, one or more selected from the group consisting of carbon nanofiber, polyaniline, polythiophene, and PEDOT: PSS may be used. The electro-conductive component may include an electro-conductive material with a length less than 1 μm that does not exhibit the action of physical reinforcement, together with the long electro-conductive material like those described above. Such a short electro-conductive material may have a length (or longest dimension, such as the long diameter) of 500 nm or more, for example.

### (Porous Material)

The porous material used in the carbon dioxide absorption-release device contains a porous substance having a large number of pores. The pore diameter of the pores is preferably 5 nm or less. Specifically, the porous material is preferably a sub-nanoporous material or a nanoporous material having pores of an angstrom size (1 nm or less) to a nanometer size, and more specifically, 0.5 nm or more and 5 nm or less.

The porous material includes reactive moieties that electrochemically perform proton transfer. Such reactive moieties may be organic molecules contained as functional groups in the molecular structure constituting the porous material. Such organic molecules can be selected and used from among those known to show redox reactions. Furthermore, derivatives of these organic molecules can also be used. Specific examples will be given later.

The porous material contains, on its surface, reactive moieties that electrochemically perform proton transfer as described above. The surface of the porous material as mentioned herein includes the outer surface and pore surfaces of the porous material. The reactive moieties may be located on the outer surface of the porous material. In addition, the reactive moieties may be contained in the pores in a state of being embedded in the pore surfaces of the porous material. Alternatively, the reactive moieties may be contained in the pores in a state of hanging from the pore surfaces of the porous material. The state of hanging from the pore surfaces of the porous material refers to, for example, the state in which the reactive moieties protrude from the pore surfaces of the porous material and hang like a pendant. The state in which the reactive moieties are embedded in the pore surface herein refers to, for example, the state in which crosslinked (bridged) functional groups (reactive moieties) whose redox state changes due to an electrical response are contained in portions corresponding to the wall surfaces of the pores in the molecular structure constituting the porous material. The state in which the reactive moieties hang from the pore surfaces refers to, for example, the state in which pendant functional groups whose redox state changes due to an electrical response are bonded to portions corresponding to the wall surfaces of the pores in the molecular structure constituting the porous material.

The proportional content of the reactive moieties that electrochemically perform proton transfer in the porous material is preferably 10 mass % or more to 90 mass % or less, and more preferably 20 mass % or more to 75 mass % or less, based on the total mass of the porous material.

The greater the number of reactive moieties, the greater the quantity of protons that can be bound per unit volume of the porous material. Therefore, from the viewpoint of energy consumption and processing efficiency, the number of reactive moieties is desirably great.

However, if the number of reactive moieties that perform proton transfer per unit volume of the porous material is too great, redox-active groups are close to each other, causing pores to be blocked, or making molecules and ions to which and from which protons are transferred hardly able to access the active groups, and as a result, there is a possibility that the active groups may not be sufficiently utilized. Therefore, the proportional content of the reactive moieties performing proton transfer within the porous material is preferably 90 mass % or less based on the total mass of the porous material. The proportional content is more preferably 75 mass % or less.

With a proportional content of the reactive moieties pf 10 mass % or more, a sufficient reaction rate of proton transfer can be achieved, and thus, excellent treatment efficiency can be achieved.

In the porous composite, reactive moieties performing proton transfer in the porous material are preferably close to or in contact with a nearby electro-conductive component. Therefore, it is preferable that the porous material covers at least a part of the surface of the electro-conductive component, or the porous material is attached to the electro-conductive component. For example, the porous material may include an electrically responsive covalent-organic framework (COF) or an electrically responsive metal-organic framework (MOF), and the COF or MOF may be included in the porous composite in a manner of covering the electro-conductive component.

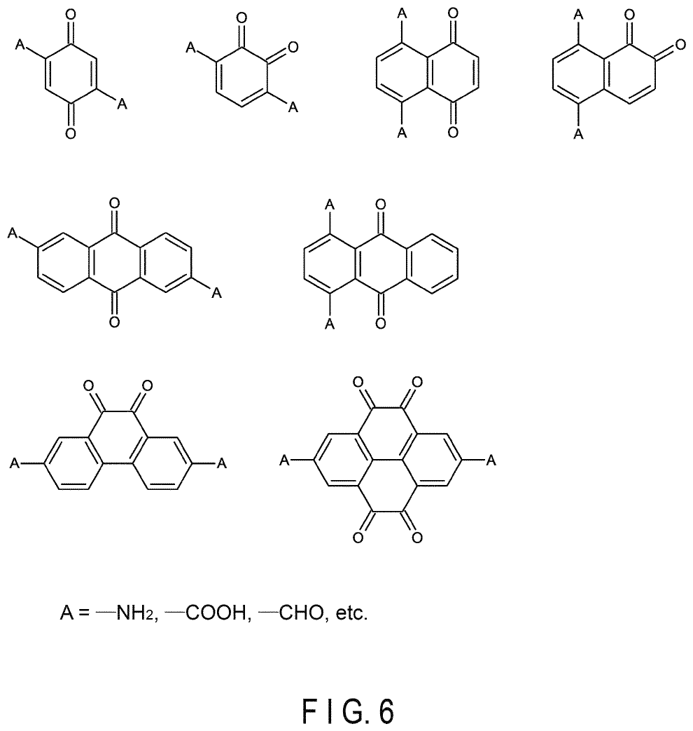

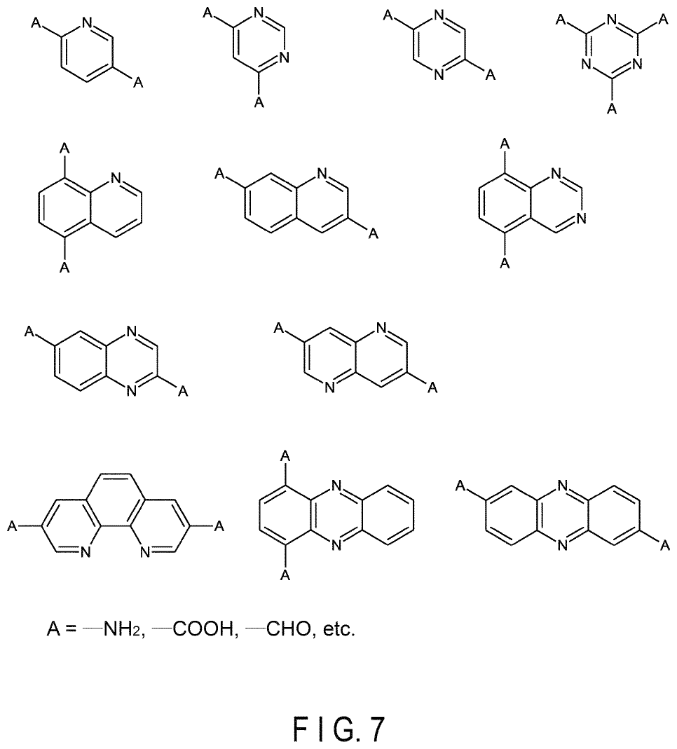

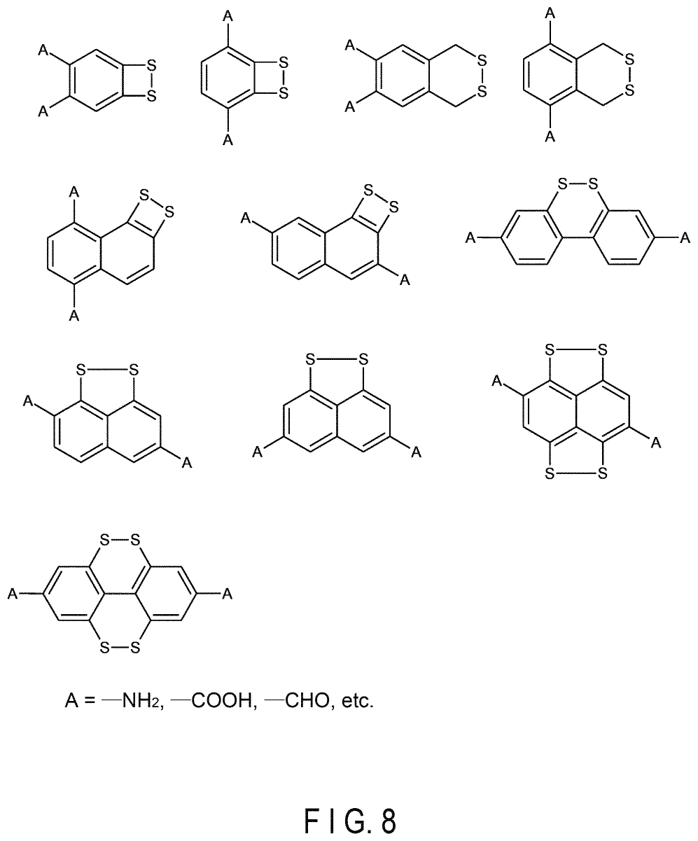

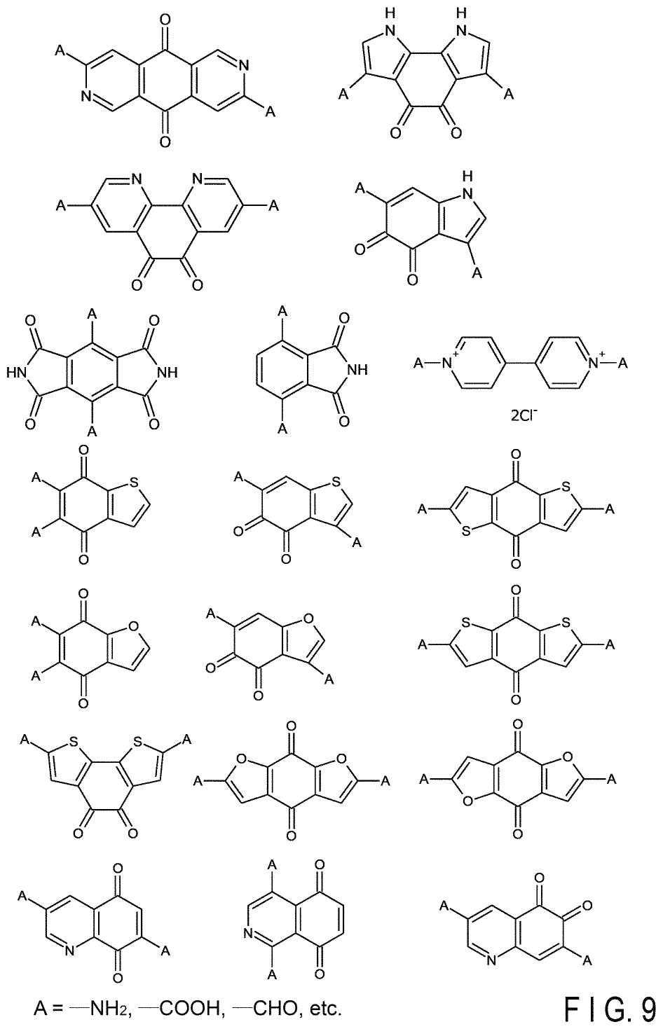

Specific examples of the organic molecule capable of functioning as redox-active reactive moieties that electrically respond in the porous material include a molecule including at least one selected from the group consisting of quinone, catechol, furan, phenazine, phenanthrene, thiophene, pyridine, pyrrole, sulfide, disulfide, and fused heteroaromatic ring quinone. FIGS. 6 to 9 illustrate examples. FIG. 6 is a list diagram showing examples of structural formulas of a quinone-based redox-active group, FIG. 7 is a list diagram showing examples of structural formulas of an N-containing redox-active group, FIG. 8 is a list diagram showing examples of structural formulas of an S-containing redox-active group, and FIG. 9 is a list diagram showing examples of structural formulas of a fused heteroaromatic ring-based redox-active group. The functional group A shown in each molecular structure shown in each drawing is, an amino group (—NH₂), a carboxyl group (—COOH), an aldehyde group (—CHO), or the like, for example, and COF or MOF can be formed using the functional group A as a linker.

The redox-active reactive moieties that responds electrically may be metal complexes. As in an example given below, COF and MOF include metal complexes, but some metal complexes other than COF and MOF can also function as reactive moieties. For example, a metal complex in which the above-described organic molecule is bonded as a ligand to a metal ion can be used. Specific examples thereof include the following:

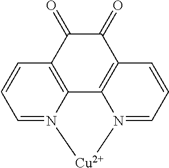

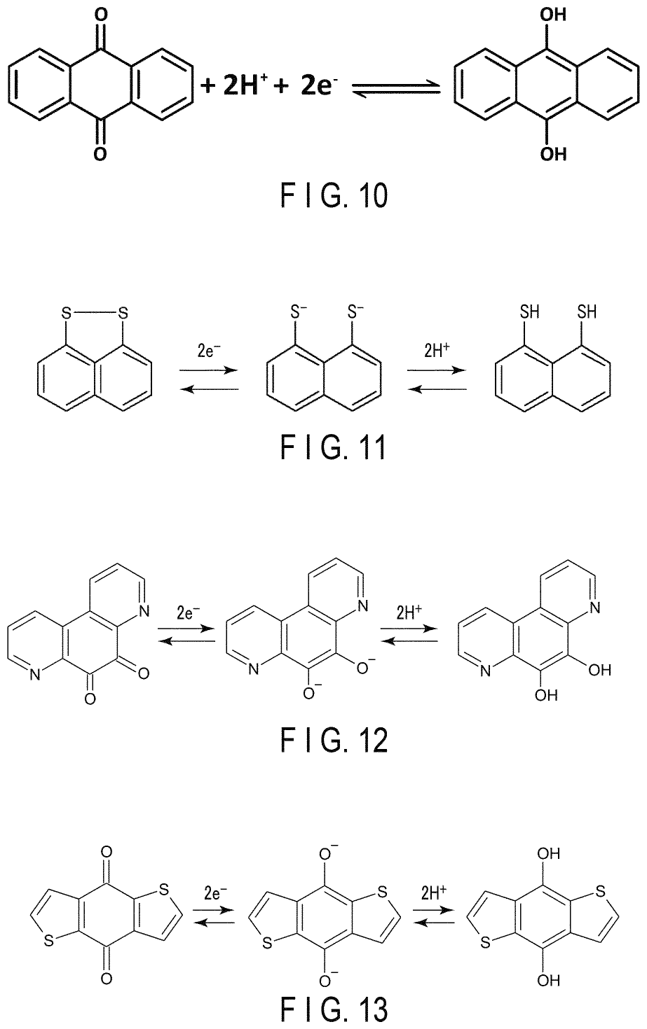

Electrochemical proton (H⁺) transfer caused by redox of a reactive moiety contained in the porous material due to an electrical response will be described with reference to an electrical response reaction by anthraquinone, which is an example of a redox-active organic molecule, taking this quinone-based redox molecule as a model reactive moiety. As in the scheme shown in FIG. 10, the anthraquinone takes in two electrons at the reduction potential, and bonds with two H⁺ from a proton source such as water. The chemical reaction reversibly proceeds, and when put into the oxidation potential, the reactive moiety releases H⁺ and returns to the original anthraquinone structure.

FIGS. 11 to 13 show other examples. In any example, as in the case of anthraquinone, the reactive moiety takes in two electrons at a reduction potential and turns into a reduction state, and are further bonded to two H⁺ from a proton source. The chemical reaction reversibly proceeds, and when put into the oxidation potential, the reactive moiety releases H⁺ and returns to the original structure.

The specific surface area of the porous material itself is preferably large. The reactive moieties that perform proton transfer in the porous material are negatively charged at a reduction potential, and become capable of bonding with protons. The adsorption amount increases as the opportunity for the reactive moieties to contact the proton source contained in the aqueous electrolyte such as water molecules (H₂O) increases. Therefore, a porous material having a specific surface area of about 10 m²/g to several 1000 m²/g is preferably used as the porous material. Thereby, a device capable of efficiently absorbing and releasing carbon dioxide can be obtained.

The porous material preferably contains one or more selected from the group consisting of a COF, an MOF, a porous carbon material, zeolite, porous silica, porous alumina, and a porous substance obtained by modifying a molecule capable of electrochemical proton transfer into pores of these porous materials. For example, the porous material may include an electrically responsive COF. Alternatively, the porous material may contain an electrically responsive MOF. In addition, the reactive moiety that electrochemically performs proton transfer may be a part of an electrically active COF or a part of an electrically active MOF.

In the COF contained in the porous material, charges desirably smoothly move to the reactive moieties performing proton transfer. Thus, formation of a three-dimensional structure through II-I stacking of two-dimensional structural units of the COF is preferable. By including such a stacked structure with II-I stacking in the porous material, the efficiency of electrical response is improved, and the energy reduction is promoted. Examples of the COF that form a three-dimensional structure by π-π stacking include TpPa COF, PA-COF, 4KT-Tp COF, 2KT-Tp COF, 1KT-Tp COF, DAAQ-TFP—COF, PI-COF-1, PI-COF-2, PI-COF-3, CS-COF, CTF-1, CTF-2, TAPB-PDA-COF, N₃-COF, COF-42, and derivatives thereof. One or more of these COFs capable of forming a stacked structure by π-π stacking is preferably included. Chemical structures of COFs that form a three-dimensional structure by II-I stacking are shown below. The specific surface area of the COFs in the above examples varies depending on the pore structure, and the amount of protons that can be theoretically bonded per unit weight of the COF varies depending on the number of redox-active points in the organic molecule.

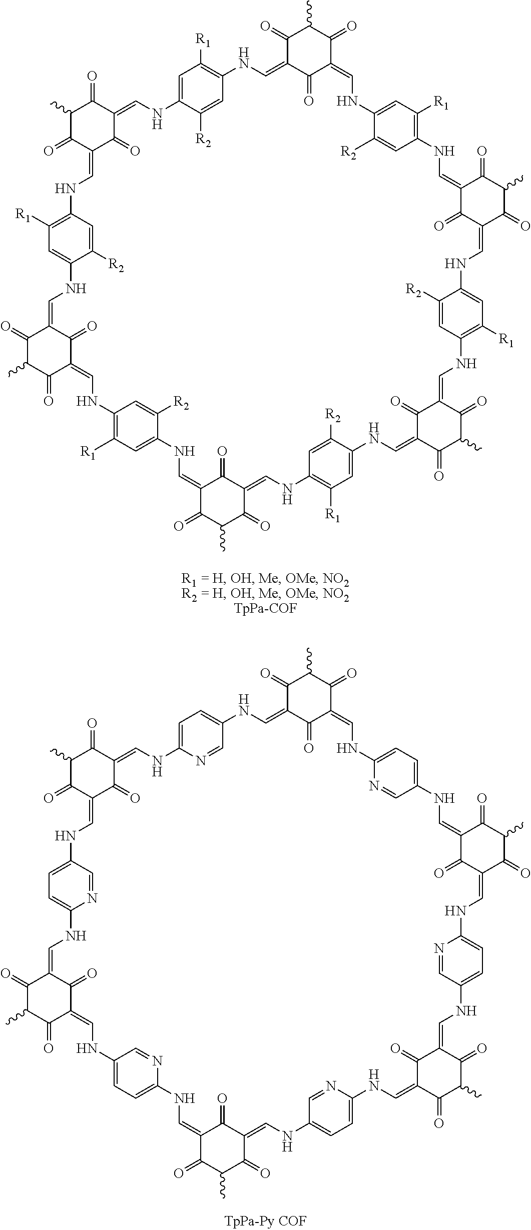

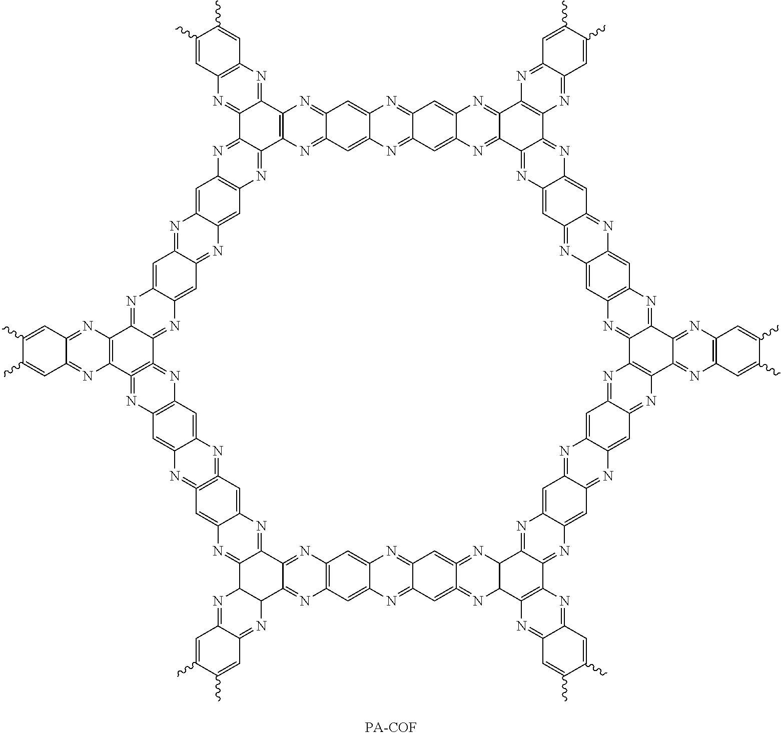

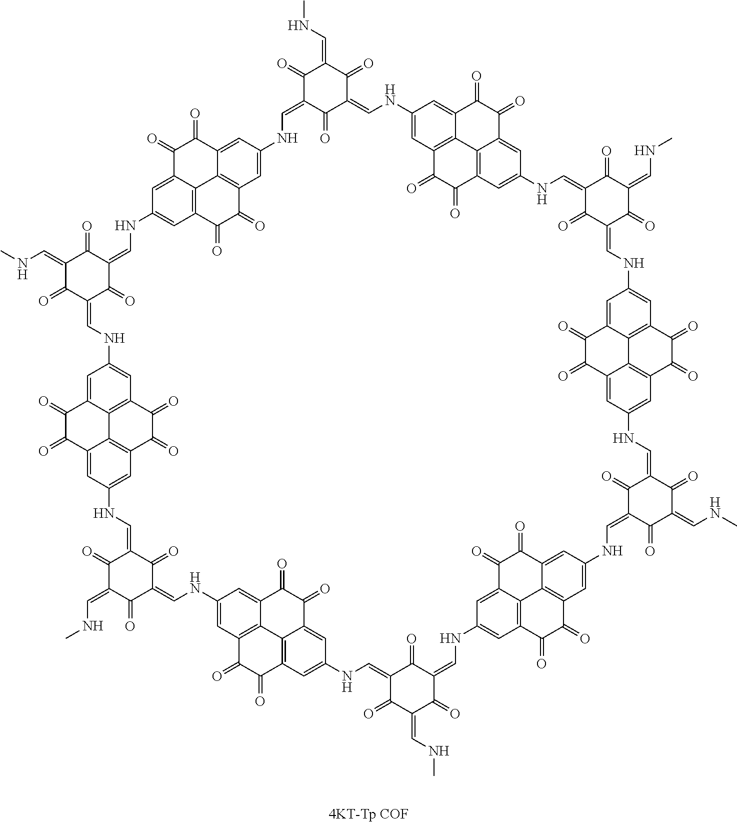

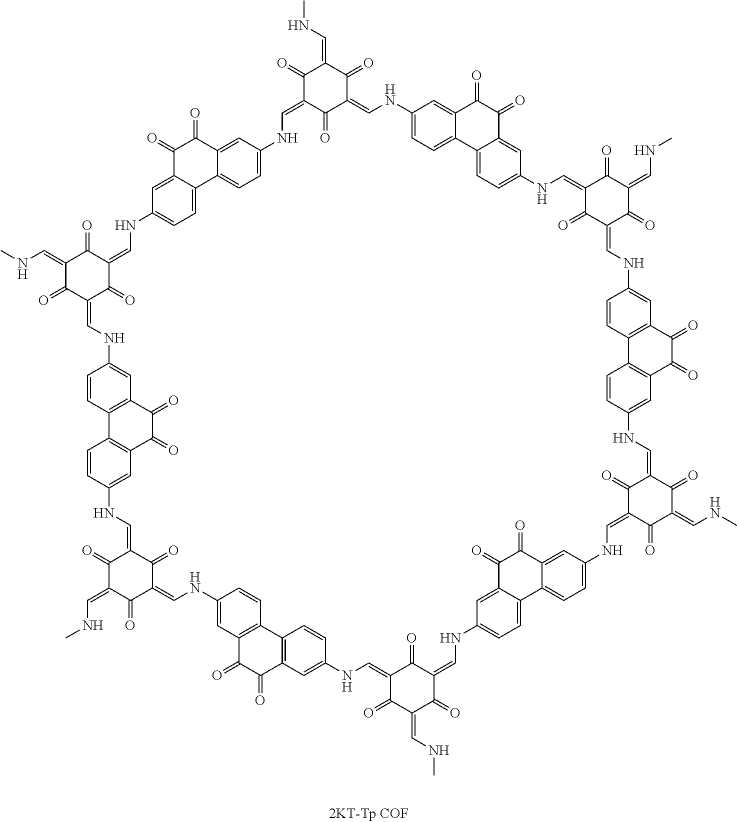

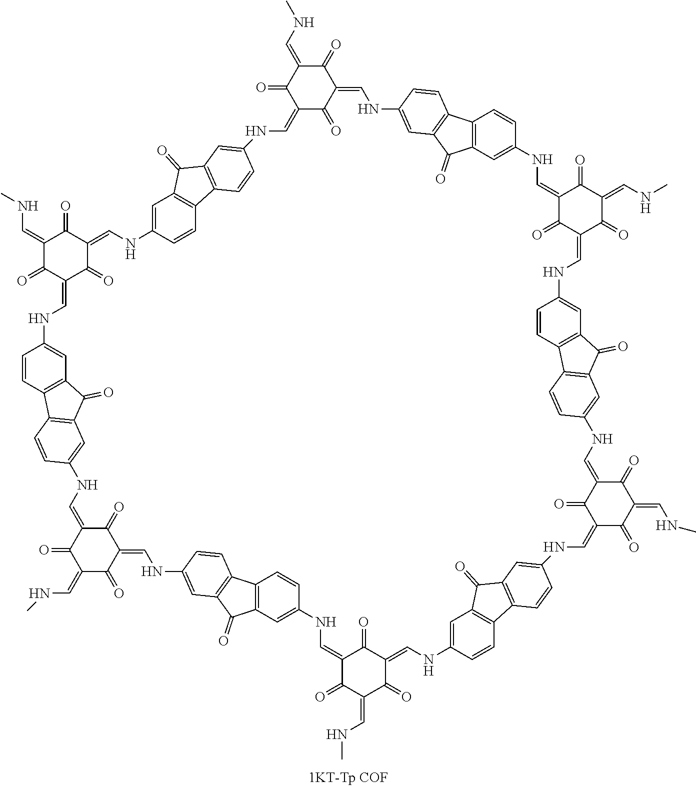

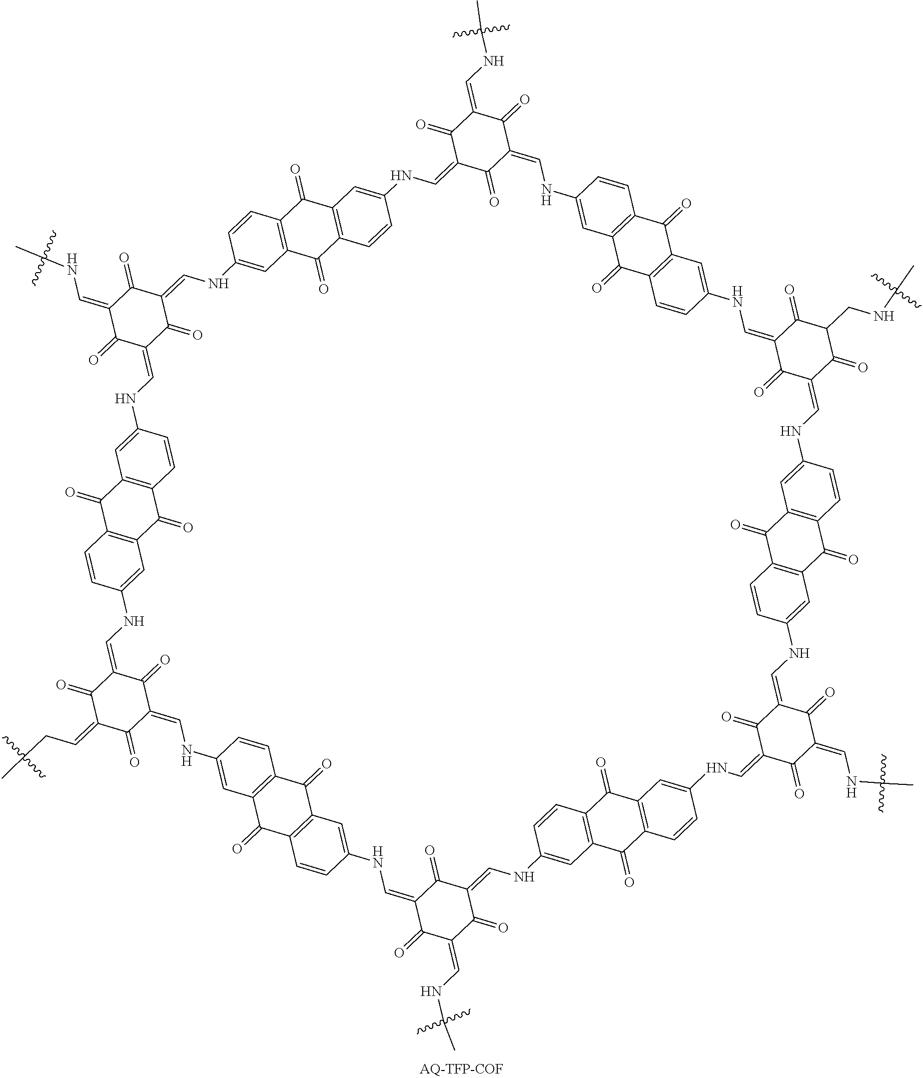 [SMILES: *C/C=C1\C(=O)c2c[nH]c3ccc4c(=O)c5cc(ccc5c(=O)c4c3)[nH]cc3c(=O)c(c[nH]c4ccc5c(=O)c6cc(ccc6c(=O)c5c4)[nH]cc4c(=O)c(c[nH]c5ccc6c(=O)c7cc(ccc7c(=O)c6c5)[nH]cc5c(=O)c(c[nH]c6ccc7c(=O)c8cc(ccc8c(=O)c7c6)[nH]cc6c(=O)c(c[nH]c7ccc8c(=O)c9cc(ccc9c(=O)c8c7)[nH]cc7c(=O)c(c[nH]c8ccc9c(=O)c%10cc(ccc%10c(=O)c9c8)[nH]cc(c2=O)C1=O)C(=O)/C(=C\N*)C7=O)C(=O)/C(=C\N*)C6=O)C(=O)C(CN*)C5=O)C(=O)/C(=C\N*)C4=O)C(=O)/C(=C\N*)C3=O]

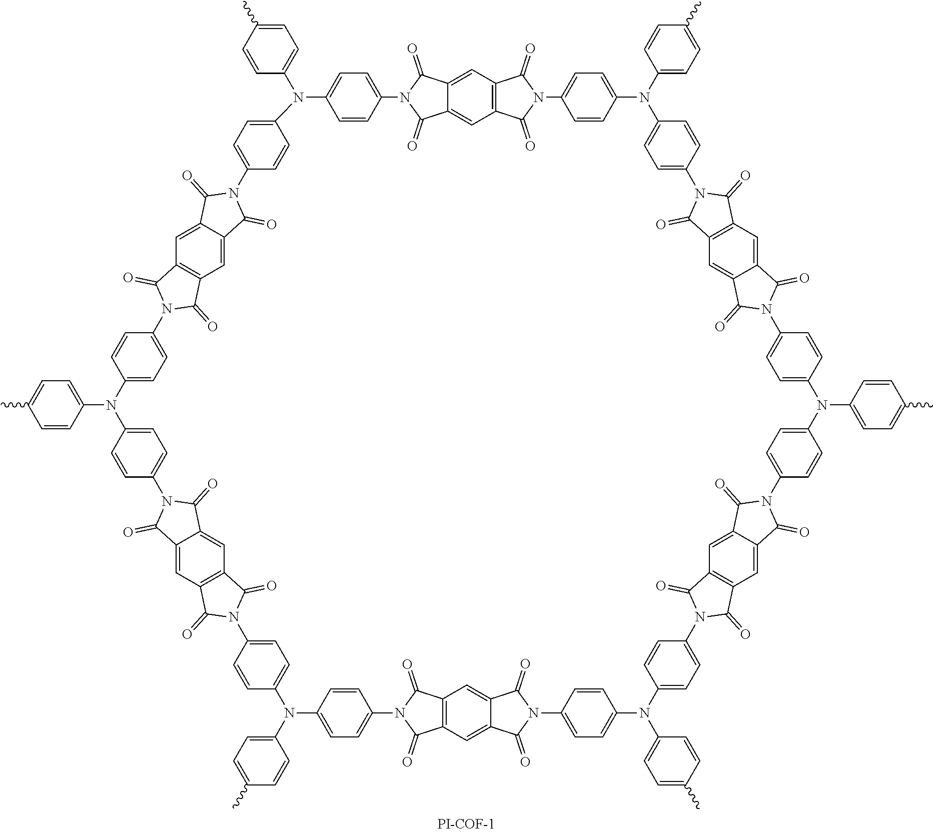

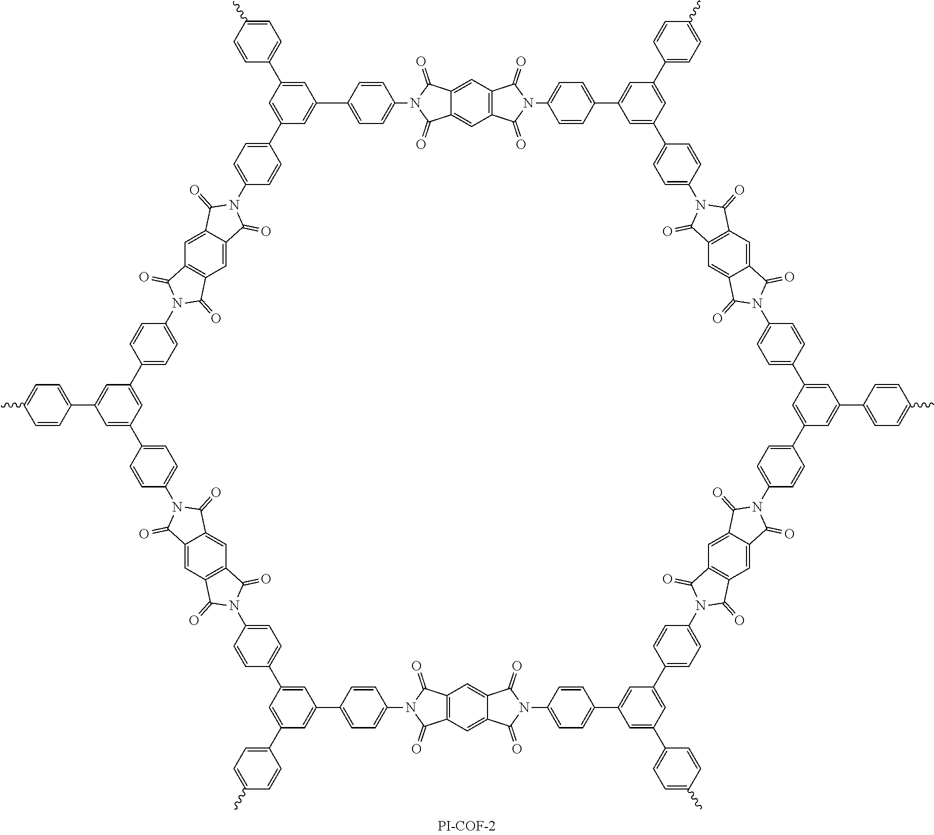

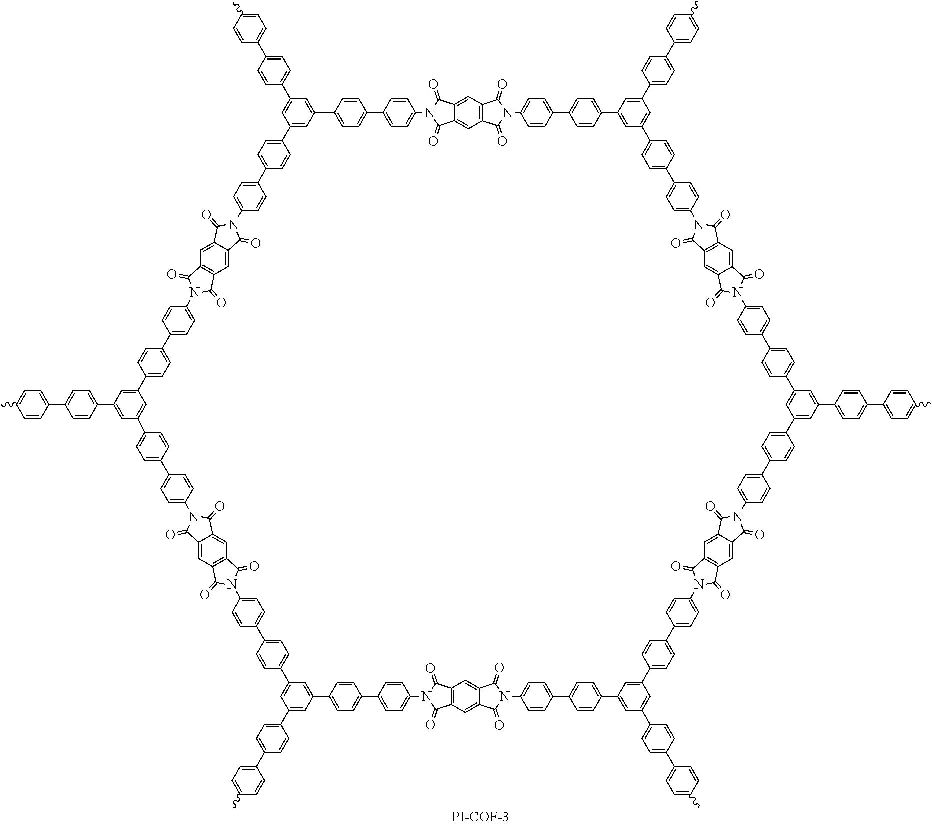

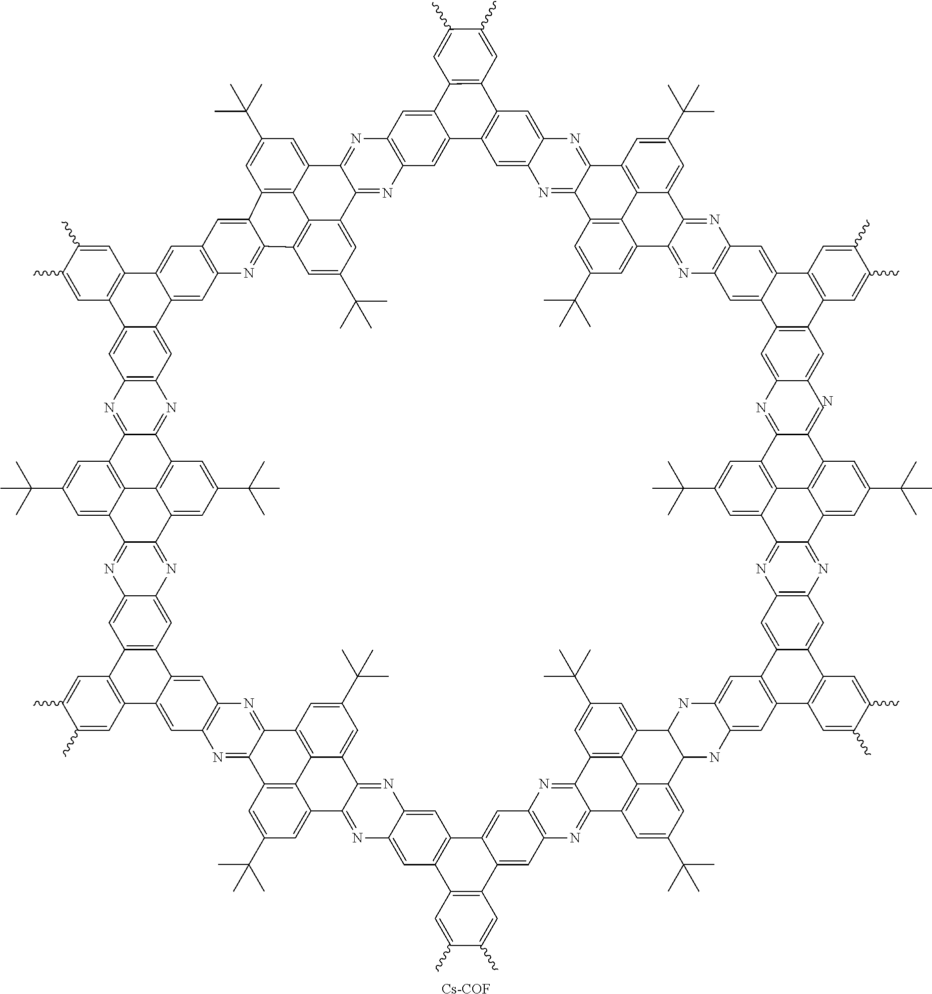

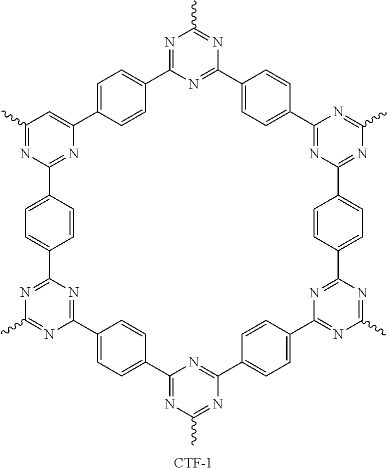

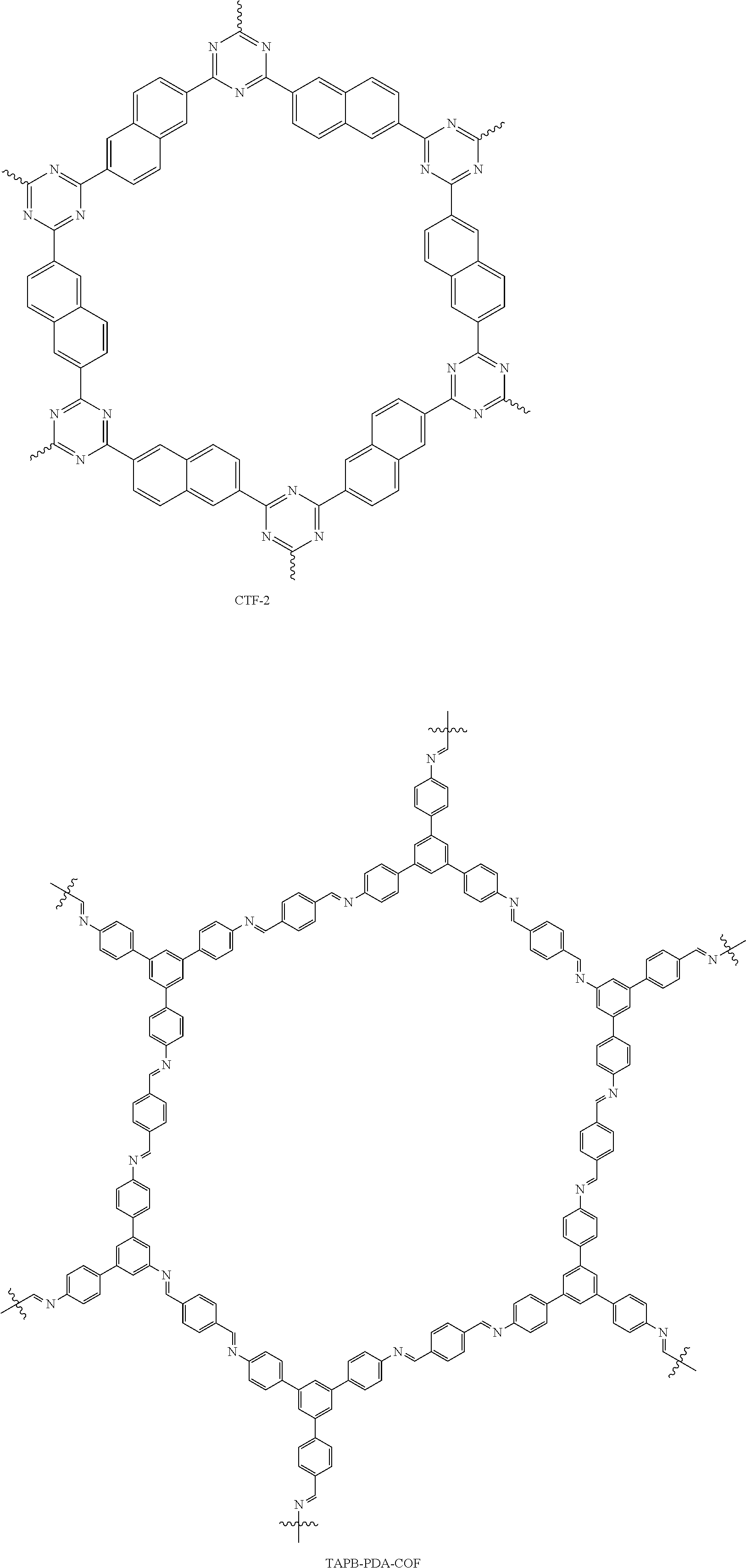

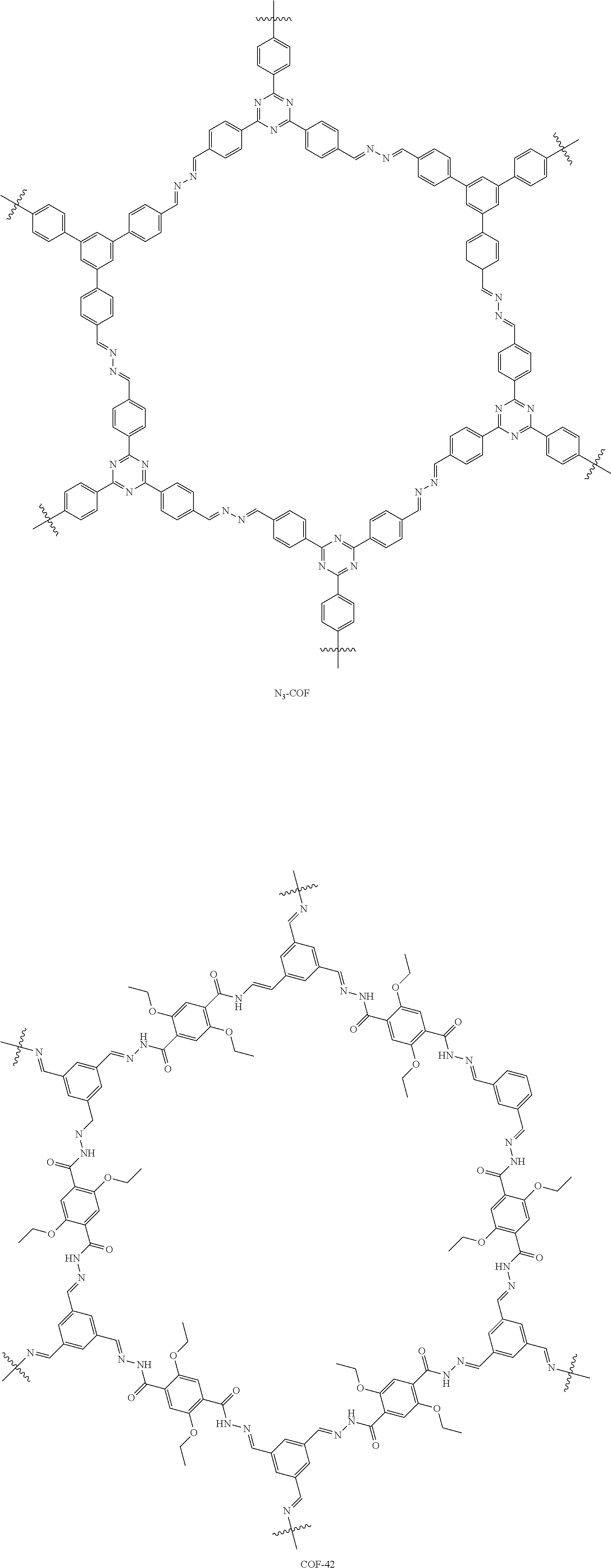

Meanwhile, a three-dimensional structure is established by ionic bonds for the MOF, and thus, the MOF preferably has high water resistance and heat resistance. In particular, an MOF having a structure in which 12 dicarboxylic acids are coordinated to a six-node Zr₆O₄(OH)₄ cluster is preferably used. The structure is shown below. In the following structures, o (white circle) represents a Zr₆O₄(OH)₄ cluster, and a solid line represents a dicarboxylic acid ligand.

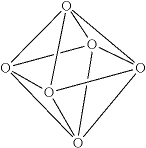

As a preferred example of an MOF having a structure in which 12 dicarboxylic acids are coordinated to the six-node Zr₆O₄(OH)₄ cluster, an MOF having a UiO (Universitet i Oslo) structure can be mentioned. For example, it is preferable to use one or more selected from the group consisting of UiO-66, UiO-67, UiO-68, and derivatives thereof. UiO-66, UiO-67, and UiO-68 have a structure in which the dicarboxylic acid ligand is 1,4-benzenedicarboxylic acid, 4,4′-biphenyldicarboxylic acid, or 4,4″-terphenyldicarboxylic acid, respectively. The above-mentioned derivative refers to a derivative obtained by introducing a new functional group into a benzene ring of a ligand included in the above-mentioned derivatives. The functional group includes, for example, an amino group, a hydroxyl group, an alkoxy group, an amide group, an aldehyde group, an acyl group, an ester group, a carbonyl group such as a carboxyl group, and the like. As other examples of the derivative, there are derivatives in which a benzene ring of the ligand is substituted with a heteroaromatic ring such as a pyridine ring or an imidazole ring. Regarding UiO-67, the derivative includes a derivative substituted with a heterocyclic compound such as 9-fluorenone-2,7-dicarboxylic acid, fluorene-2,7-dicarboxylic acid, or carbazole-2,7-dicarboxylic acid, instead of 4,4′-biphenyldicarboxylic acid.

Specific examples of the MOF having a UiO structure include 2,6-Zr-AQ-MOF (Zr₆O₄(OH)₄ (C₁₆O₆H₆)₆(C₃H₇NO₃)₁₇(H₂O)₂₂) and 1,4-Zr-AQ-MOF (Zr₆O₄(OH)₄ (C₁₆O₆H₆)₄ (C₂O₂H₃)_{2.76}(CO₂H)_{1.24}(C₃H—NO)₁₁(H₂O)₄₀). In these MOFs, as dicarboxylic acid ligands coordinated to the six-node Zr₆O₄(OH)₄ cluster, 2,6-dicarboxy-9, 10 anthraquinone and 1,4-dicarboxy-9, 10 anthraquinone are coordinated and present on the surfaces of pores. In such a manner, anthraquinone is included as a bridged functional group. The structures of these MOFs are shown below. In the following, a simplified structure is illustrated in which only one anthraquinone is clearly shown and the remaining 11 anthraquinones (solid lines) are omitted.

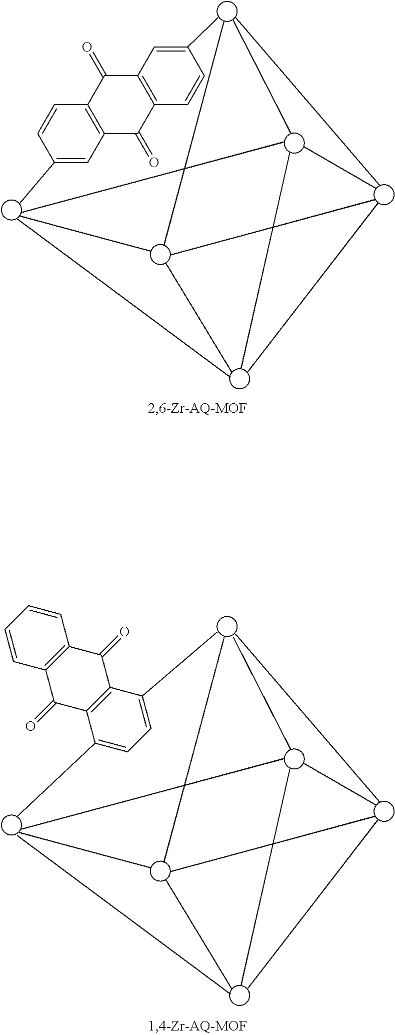

Other specific examples of MOFs having a UiO structure include 2,6-Zr-PQ-MOF, 2,5-Zr-PD-MOF, and 2,6-Zr-BDD-MOF. Comparing these MOFs with the examples given above, 9,10-phenanthrene quinone (PQ), pyridine (PD), or benzo-[1,2-b: 4,5-b′]-dithiophene-4,8-dione (BD) is coordinated in place of anthraquinone. Structures of 2,6-Zr-PQ-MOF and 2,5-Zr-PD-MOF are shown below.

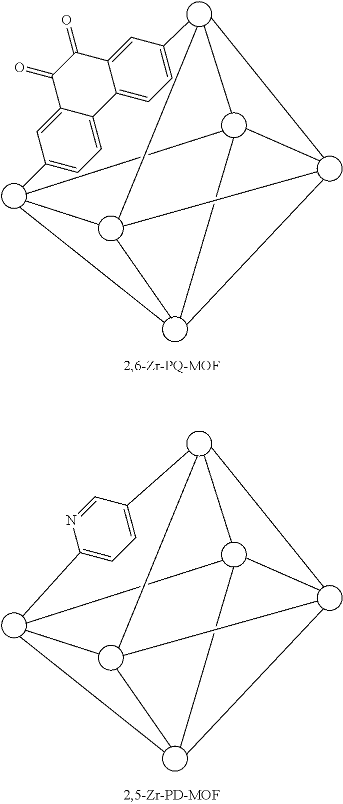

Other examples of the MOF include MOFs having a Cu(2,7-anthraquinone dicarboxylic acid) structure (Cu(2,7-AQDC) structure), a Mn(2,7-anthraquinone dicarboxylic acid) structure (Mn(2,7-AQDC) structure), or an IRMOF structure. Furthermore, an example is an MOF having a structure analogous to IRMOF-9 in which biphenylene dicarboxylic acid is substituted with anthraquinone dicarboxylic acid.

Cu(2,7-AQDC) has a network structure in which 10 bridged 2,7-AQDC ligands are coordinated to paddle wheel binuclear complex Cu₂(Ac)₄ clusters as nodes. A n-I interaction may occur between some 2,7-AQDC ligands, and the structure is reinforced by the n-n interaction. Mn (2,7-AQDC) has a lattice structure in which bridged 2,7-AQDC ligands are coordinated to Mn complex clusters. The specific surface area of the MOF in the above examples varies depending on the pore structure, and the amount of H⁺ that can be theoretically bonded per unit weight of the MOF varies depending on the number of redox-active points in the organic molecule.

Porous substances used as the porous material are not limited to the above materials. For example, activated carbon, mesoporous silica, or the like can also be used as the porous body. Activated carbon or mesoporous silica may be used alone as is, or a material modified with an electroactive group may be used. Alternatively, a porous polymer that contains reactive moieties performing proton transfer can be formed and used for the porous material. However, since providing pores in the polymer is difficult, limiting the surface area, the above-described material having pores, particularly COF or MOF, are preferably used for the porous material.

The MOF may include one or more central metals selected from the group consisting of zirconium, copper, and manganese. The central metal may be, for example, the central metal of a metal complex, which may be contained within the MOF as a cluster. For example, the MOF having the UiO structure described above contains clusters of Zr₆O₄(OH)₄, which are complexes containing zirconium as the central metal. Cu(2,7-AQDC) includes clusters of complexes containing copper as the central metal, and Mn(2,7-AQDC) includes clusters of complexes containing manganese as the central metal.

The presence of reactive moieties electrochemically performing proton transfer in the complex can be confirmed by a pH change associated with an electrochemical reaction in aqueous solution. As shown in the above reaction formula 1, when electrons are supplied to the reactive moieties, protons are extracted from H₂O in the aqueous solution, and the OH-concentration in the liquid increases. The resulting increase in pH is measured with a pH meter. The pH measurement is performed at 25±2° C. As the aqueous solution, an aqueous electrolyte that can be used for the carbon dioxide absorption-release device can be used.

The presence of a COF or MOF in the composite is examined in two stages. First, thermogravimetric analysis (TG) is performed under an inert atmosphere. If the weight loss of a binder component is observed at 200° C. to 300° C. and weight loss is also observed at 300° C. to 500° C., it is assumed that a COF or MOF is present in the composite. The electro-conductive component is not decomposed until the temperature reaches near 1000° C., in an inert atmosphere. When the weight loss is observed at 300° C. to 500° C., X-ray diffraction (XRD) analysis is further performed. When it is confirmed that one or two diffraction peaks derived from a COF or MOF appear in the range of 3° to 10° other than the diffraction peaks derived from the electro-conductive component (20° to) 30°, it is determined that the composite contains a COF or MOF.

The presence of a COF or MOF on the surface of the electro-conductive component is examined by a scanning transmission electron microscope (STEM). If it is confirmed by STEM observation that a layer different from the electro-conductive component is stacked on the surface of the electro-conductive component, it is direct evidence that the surface is covered.

Both the COF and the MOF may be contained in the porous composite. That is, the porous composite may contain at least one of COF and MOF. If both the COF and the MOF are contained in the porous composite, the analysis results should be similar to those described above.

The porous material preferably thinly covers the surface of the electro-conductive component with a thickness of 1 nm or more and 5 nm or less. The more thinly the porous material covers the electro-conductive component, the higher the electrical conductivity of the porous composite, and greater the reactive moieties where H⁺ is exchanged, as well. Although MOF and COF originally have a very large specific surface area and can contain many active points, MOF or COF alone has an electrical path only near the surface because their electrical conductivities are not as high as metal. Therefore, since the internal reactive moieties cannot contribute to H⁺ exchange, there is a high possibility that the high specific surface area is not utilized. In order to take advantage of a high specific surface area of the MOF or the COF, namely, a high active point density, for example, the MOF or the COF is desirably brought into direct contact with a surface of an electrically conductive support to effectively pass an electrical path, and so, preferably thinly covered onto the surface of the electro-conductive component.

The porous composite can be obtained by combining the electro-conductive component and the porous material. The compositing is performed, for example, by mixing the electro-conductive component and the porous material or modifying (covering) the surface of the electro-conductive component with the porous material. Specifically, the porous composite is synthesized, for example, by adding the first electro-conductive component to a raw material liquid containing a raw material used for synthesis of the porous material as a single entity. Raw materials of the porous material include organic molecules exhibiting redox activity due to electrical response.

The porous substance used for the porous material preferably has a structure that does not change even when made a composite with the electro-conductive component. This is because, when the structure of the porous material is altered, the specific surface area is reduced or pores are diminished, reducing effective reactive moieties, whereby the reactivity of proton transfer and ultimately the ability to absorb and release carbon dioxide are lowered.

The specific surface area of the porous composite can be evaluated by a method by which molecules having a known adsorption occupancy area are adsorbed onto the surface of powder particles, and the specific surface area of the sample is determined from the amount of the molecules. For example, if the porous composite is provided on a current collector, just the composite portion is scraped off as much as possible from the current collector, and the collected powder is subjected to vacuum degassing at 120° C. for eight hours with the pretreatment device BELPREP-VAC II manufactured by MicrotracBEL Corp. Thereafter, the specific surface area is measured at an adsorption temperature of 77 K using the specific surface area/pore distribution analyzer BELSORP-MINI II manufactured by MicrotracBEL Corp. As the gas to be adsorbed, for example, nitrogen is used.

The electrode containing the porous composite can be produced as described below, for example.

First, a porous composite is prepared. The porous composite, the second electro-conductive component, and a binder are added to a solvent. The obtained mixture is kneaded to prepare a paste. This paste is applied onto, for example, the current collector. For example, if a flat plate-shaped current collector is used, the paste is applied onto one side or both sides thereof. Then, the applied paste is heated and dried to obtain an electrode containing the current collector and the porous composite.

The above is merely an example, and the paste may not necessarily contain a binder. Depending on the properties of the electro-conductive component, the paste may be turned into a free-standing electrode by heating and drying. That is, an electrode containing the porous composite alone may be obtained, for example, without using the current collector.

### (Aqueous Electrolyte)

The aqueous electrolyte contains a solvent containing water and an electrolyte.

The solvent contains at least water. The solvent may be pure water, or may contain a liquid or a solvent other than water. However, the content of water in the solvent is 50 mass % or more. The content of water in the solvent is preferably 60 mass % or more, more preferably 70 mass % or more, and still more preferably 80 mass % or more.

The electrolyte contains cations and anions. The electrolyte is, for example, dissociated within the aqueous electrolyte, and exists as cations and anions. Examples of preferable cations include, but are not particularly limited to, a hydrogen ion, a lithium ion, a sodium ion, a potassium ion, a magnesium ion, a calcium ion, an ammonium ion, an imidazolium ion, a pyridinium ion, and a quaternary alkylammonium ion. Examples of preferred anions include a hydroxide ion, a fluoride ion, a chloride ion, a bromide ion, an iodide ion, a nitrate ion, a perchlorate ion, a formate ion, an acetate ion, a bicarbonate ion, a carbonate ion, a dihydrogen phosphate ion, a monohydrogen phosphate ion, a phosphate ion, a sulfate ion, an oxalate ion, a tartrate ion, a citrate ion, a borate ion, a tetrafluoroborate ion, a hexafluorophosphate ion, and a trifluoromethanesulfonate ion. The electrolyte is not necessarily constituted of one species each of cation and anion, and may be a mixture of multiple components.

The concentration of the electrolyte contained in the aqueous electrolyte is, for example, 0.01 M or more and 1 M or less.

### EXAMPLES

Hereinafter, examples of the carbon dioxide absorption-release device will be described.

### Example 1

### <Synthesis of Porous Composite>

A porous composite was prepared by modifying carbon nanotube (CNT) as electro-conductive component with TpPa-Py COF. TpPa-Py COF contains pyridine (PD) as reactive moieties that electrochemically perform proton transfer, and has the structure shown above. Hereinafter, TpPa-Py COF will be simply referred to as PD-COF. CNT was added to a raw material solution containing 2,5-diaminopyridine (TpPa-Py) such that TpPa-Py: CNT=10:12(weight ratio), with reference to Non-Patent Document Mater. Chem. Front., 2017, 1, 1310-1316; Qui Sun, et al. 1,3,5-triformylphloroglucinol (TFP) was added at TpPa-Py: TFP=10:13, to synthesize a PD-COF-CNT composite. The product was washed by extraction with methanol at 105° C. for 12 hours using Soxhlet, and then dried under reduced pressure at 120° C. for two hours.

### <Membrane Formation on Current Collector>

The PD-COF-CNT composite obtained as described above, Ketjen black, and PVdF were added to NMP such that PD-COF-CNT composite: Ketjen black: PVdF=8:1:1(weight ratio). The resulting mixture was kneaded until a well pasty form was obtained. The formed paste was applied onto a current collector. A graphite sheet was used as the current collector. The paste was air-dried overnight and then dried under reduced pressure at 110° C. for two hours to obtain an electrode.

### <Preparation of Aqueous Electrolyte>

Lithium perchlorate was added to pure water at 0.5 M to prepare an aqueous electrolyte. The electrolyte was degassed with nitrogen gas in advance upon introduction into the device.

### <Assembly of Device>

Using the electrode and the aqueous electrolyte, a device having the same structure as the carbon dioxide absorption-release device 100 shown in FIGS. 1 and 2 was prepared. The prepared electrode was used for both the first electrode 11 and the second electrode 21. As the membrane 30, an anion exchange membrane was used. In this manner, the device of Example 1 was obtained.

### Example 2

A porous composite was prepared by modifying CNT as electro-conductive component with AQ-TFP-COF as a porous material. AQ-TFP-COF contains 9,10-anthraquinone (AQ) as reactive moieties electrochemically performing proton transfer, and has the structure described above.

Hereinafter, AQ-TFP-COF will be simply referred to as AQ-COF. As a reactant for obtaining the COF, 2,6-anthraquinone diamine (DAAQ) was prepared with reference to Non-patent Literature Carbon 171 (2021) 248-256; Xueying Kong, et al. CNT was added to a raw material solution containing DAAQ at DAAQ: CNT=10:12(weight ratio). TFP was further added to the resulting solution at DAAQ: TFP=10:5(weight ratio), thereby synthesizing an AQ-COF-CNT composite. The product was washed by extraction with methanol at 105° C. for 12 hours using Soxhlet, and then dried under reduced pressure at 120° C. for two hours.

A device similar to Example 1 was prepared except that the porous composite used for the electrode was changed to the AQ-COF-CNT composite obtained above, thereby obtaining a device of Example 2.

### Example 3

A porous composite was prepared by modifying CNT as electro-conductive component with 2KT-Tp COF. 2KT-Tp COF contains 9,10-phenathrenequinone (PQ) as reactive moieties electrochemically performing proton transfer, and has the structure described above. Hereinafter, 2KT-Tp COF will be simplified and referred to as PQ-COF. CNT was added to a raw material solution containing 2,7-diaminophenanthrene-9,10 dione (2KT-BD) at 2KT-BD: CNTs=5:6(weight ratio) with reference to Non-patent Literature CCS Chem. 2020, 2, 696-706; Miao Li, et al. TFP was further added to the resulting solution at 2KT-BD: TFP=10:5(weight ratio), thereby synthesizing a PQ-Tp COF-CNT composite. The product was washed by extraction with methanol at 105° C. for 12 hours using Soxhlet, and then dried under reduced pressure at 120° C. for two hours.

A device similar to Example 1 was prepared except that the porous composite used for the electrode was changed to the PQ-COF-CNT composite obtained above, thereby obtaining a device of Example 3.

### Example 4

A porous composite was prepared by modifying carbon nanofiber (CNF) as electro-conductive component with BDD-TFP-COF. BDD-TFP-COF contains benzo[1,2-b: 4,5-b′]dithiophene-4,8-dione (BDD) as reactive moieties electrochemically performing proton transfer. Hereinafter, BDD-TFP-COF will be simply referred to as BDD-COF. 1,5-diamino BDD and TFP were placed in a heat-resistant container at a molar ratio of 1:3 and heated with a dioxane solvent at 120° C. for two days with reference to Non-patent Literature J. Am. Chem. Soc., 2013, 135, 16821-16824. The obtained crude crystals were washed with a dimethylacetamide (DMA) solvent, filtered, and dried under reduced pressure to obtain BDD-COF. The obtained BDD-COF was mixed with CNF and polyvinylidene fluoride (PVdF) in an N-methylformaldehyde solvent (NMF solvent) at a mass ratio of 6:3:1, and applied onto a carbon felt to obtain an electrode.

A device similar to that of Example 1 was prepared except that the electrodes were changed to that described above, thereby obtaining a device of Example 4.

### Example 5

A porous composite was prepared by modifying CNT as electro-conductive component with 2,6-Zr-AQ-MOF. 2,6-Zr-AQ-MOF has a UiO structure containing 9,10-anthraquinone (AQ) as reactive moieties electrochemically performing proton transfer, and has the structure described above. Hereinafter, 2,6-Zr-AQ-MOF will be simply referred to as AQ-MOF. CNT was added to a raw material solution containing 2,6-dicarboxy-9,10-anthraquinone (2,6-AQ) at CNT: 2,6-AQ=8:1(weight ratio) with reference to Non-patent Literature Inorg. Chem. 2017, 56, 13741-13747, Paul J. Celis-Salazar, et al., thereby synthesizing an AQ-MOF-CNT composite. The product was subjected to suction filtration with dimethylformamide (DMF), washed with DMF, and dried under reduced pressure at 120° C. for two hours.

A device similar to Example 1 was prepared except that the porous composite used for the electrode was changed to the AQ-MOF-CNT obtained above, thereby obtaining a device of Example 5.

### Example 6

A porous composite was prepared by modifying CNT as electro-conductive component with 2,6-Zr-PQ-MOF. 2,6-Zr-PQ-MOF has a UiO structure containing 9,10-phenanthrenequinone (PQ) as reactive moieties electrochemically performing proton transfer, and has the structure described above. Hereinafter, 2,6-Zr-PQ-MOF will be simply referred to as PQ-MOF. A PQ-MOF-CNT composite was obtained by the same synthesis method as in Example 5 except that 2,7-dicarboxyphenanthrene-9,10-dione was used instead of 2,6-AQ.

A device similar to Example 1 was prepared except that the porous composite used for the electrode was changed to the PQ-MOF-CNT composite obtained above, thereby obtaining a device of Example 6.

### Example 7

A porous composite was prepared by modifying CNT as electro-conductive component with 2,6-Zr-BDD-MOF. 2,6-Zr-BDD-MOF contains BDD as reactive moieties that electrochemically performs proton transfer. Hereinafter, 2,6-Zr-BDD-MOF will be simply referred to as BDD-MOF. A BDD-MOF-CNT composite was obtained by the same synthesis method as in Example 5 except that 1,5-diamino BDD was used instead of 2,6-AQ.

A device similar to Example 1 was prepared except that the porous composite used for the electrode was changed to the BDD-MOF-CNT composite obtained above, thereby obtaining a device of Example 7.

### Example 8

A porous composite was prepared by modifying CNT as electro-conductive component with 2,5-Zr-PD-MOF. 2,5-Zr-PD-MOF contains pyridine (PD) as reactive moieties that electrochemically performs proton transfer, and has the structure shown above. Hereinafter, 2,5-Zr-PD-MOF will be simply referred to as PD-MOF. A PD-MOF-CNT composite was obtained by the same synthesis method as in Example 5 except that 2,5-diaminopyridine (TpPa-Py) was used instead of 2,6-AQ.

A device similar to Example 1 was prepared except that the porous composite used for the electrode was changed to the PD-MOF-CNT composite obtained above, thereby obtaining a device of Example 8.

### Example 9

Poly(benzoquinonyl sulfide) (Poly-BQS) was synthesized with reference to Non-patent Literature Adv. Sci. 2015, 2, 1500124; Z. Song et al. CNT was added to a raw material solution containing Poly-BQS at Poly-BQS: CNT=1:3(weight ratio). Four sets of ultrasonic mixing were performed for five minutes each, and then 5 wt % Nafion was added at Poly-BQS-CNT composite: Ketjen black: Nafion=8:1:1 (weight ratio). Further, two sets of five minute ultrasonic mixing were performed to prepare an ink. Carbon paper was spray-coated with the obtained ink, and then heated at 130° C. for one hour to obtain an electrode.

A device similar to that of Example 1 was prepared except that the electrodes were changed to that described above, thereby obtaining a device of Example 9.

### Comparative Example 1

As a device of Comparative Example 1, a device was obtained as described below, in which reactive moieties electrochemically performing proton transfer were not supported on an electrode, and instead, an equivalent substance was added within a solution of an aqueous electrolyte.

A graphite sheet alone was used as an electrode. Benzo [1,2-b: 4,5-b′]dithiophene-4,8-dione (BDD) was prepared as a redox molecule exhibiting electrical responsiveness. An aqueous electrolyte similar to that of Example 1 was prepared, and BDD was added to the obtained electrolyte. The addition amount of BDD was adjusted such that the amount of BDD contained in the entire device was equivalent to the amount of BDD contained in the electrode of the device of Example 4. A device similar to that of Example 1 was prepared except that the electrodes and the aqueous electrolyte were changed to those described above, thereby obtaining a device of Comparative Example 1.

### (Evaluation)

### <Electrochemical Measurement>

The electrodes used in the devices prepared in Examples 2 and 5 were evaluated for electrochemical performance. Specifically, a test device was constructed by adding a reference electrode and a potentiostat to each prepared device (not illustrated in the drawings) to perform cyclic voltammetry (CV) measurement. As the reference electrode, an Ag/AgCl electrode (0.5M (M: mol/l) lithium perchlorate aqueous solution/0.01M AgNO₃) was used.

Before the measurement, nitrogen (N₂) gas was passed through the electrolyte in each tank and the space above the electrolyte from a sweep gas introduction pipe for about 30 minutes. CV measurement was performed using the potentiostat. Subsequently, 100% carbon dioxide gas was passed through each nozzle into the electrolyte for about 30 minutes, and CV measurement was performed again. During each gas flow and CV measurement, the electrolyte was continuously circulated through the device. In addition, CV measurement was performed regarding the electrode functioning as cathode to be a working electrode and the electrode functioning as anode to be a counter electrode.

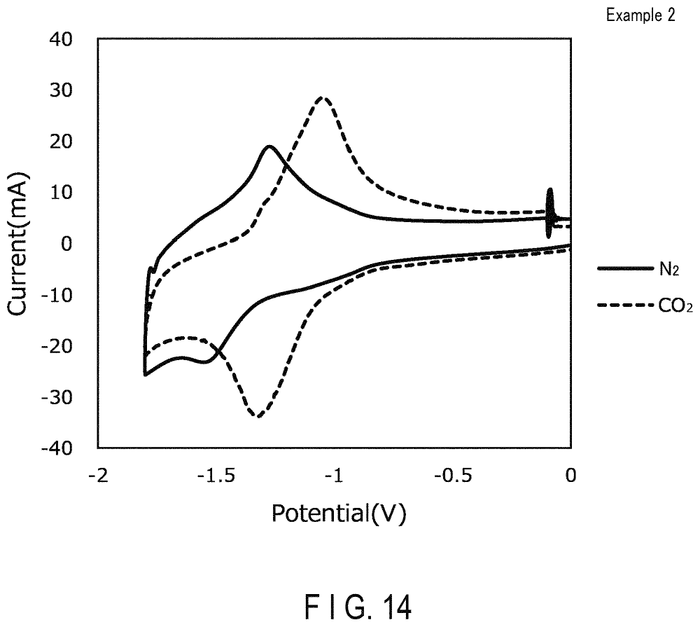

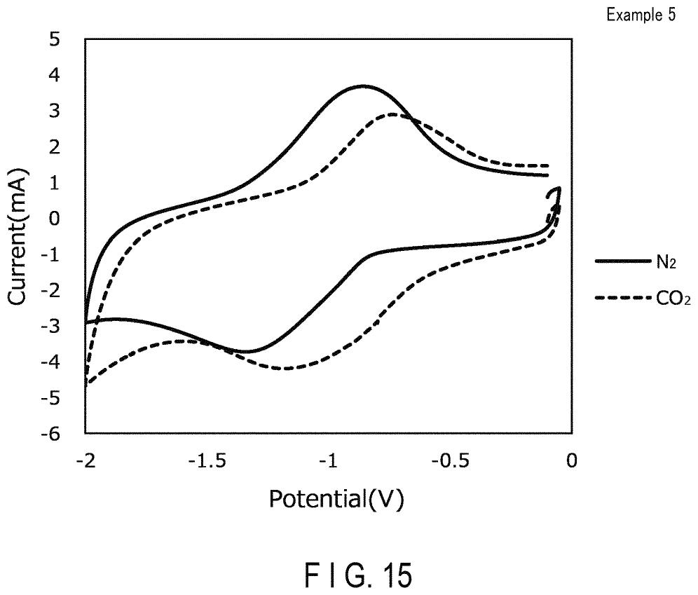

FIGS. 14 and 15 show, as a specific example, CV measurement results of AQ-COF and AQ-MOF of Examples 2 and 5, respectively. Each figure is a graph showing cyclic voltammetry curves of the porous composites prepared in Example 2 and Example 5. In each graph, a curve in the first CV measurement under a nitrogen atmosphere is indicated by a solid line, and a curve in the second CV measurement under a CO₂ atmosphere is indicated by a broken line.

### <CO₂ Absorption/Release Test>

A carbon dioxide absorption/release test was performed using the devices prepared in Examples 1 to 9 and Comparative Example 1. Each device was operated for a set period of time under the same conditions, and the amount of CO₂ recovered during that period was measured.

Table 1 below summarizes, for the devices produced in Examples 1 to 9 and Comparative Example 1, the porous material or redox molecule in each device, the structural formula of the reactive moiety electrochemically performing proton transfer in the porous material or redox molecule, and the amount of CO₂ recovered by each device in the CO₂ absorption/release test. As the porous material or the redox molecule, the porous material contained in the porous composite of the electrode is shown in Examples 1 to 9, and the redox molecule added to the electrolyte is shown in Comparative Example 1.

TABLE 1

| | Porous | Reactive moiety/ | CO₂ |
|---|---|---|---|
| | material/ | organic molecule | recovery |
| | redox | performing | amount |
| | molecule | proton transfer | (mmol/g) |
| Example 1 | PD-COF | 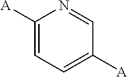 | 2.6 |
| Example 2 | AQ-COF | 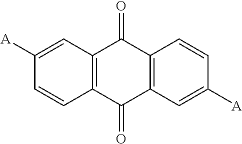 | 2.5 |
| Example 3 | PQ-COF | 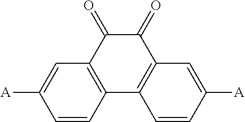 | 2.4 |
| Example 4 | BDD-COF | 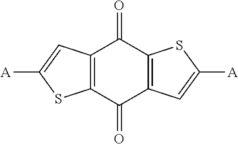 | 2.6 |
| Example 5 | AQ-MOF | 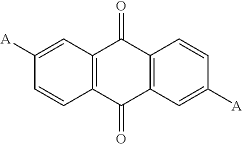 | 1.8 |
| Example 6 | PQ-MOF | 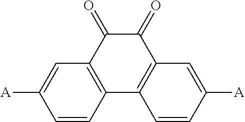 | 1.7 |
| Example 7 | BDD-MOF | 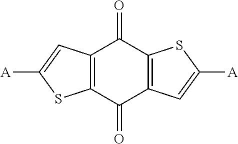 | 1.9 |
| Example 8 | PD-MOF | 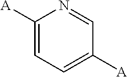 | 2.2 |
| Example 9 | BQS polymer | 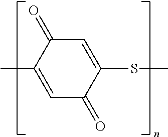 | 1.4 |
| Com- parative Example 1 | BDD (Added to electrolyte) | 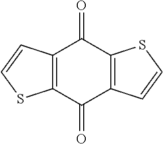 [SMILES: O=C1c2ccsc2C(=O)c2ccsc21] | 1.2 |

In a comparison between the devices of Example 1 to Example 9, in which the porous composite containing reactive moieties electrochemically performing proton transfer was fixed to electrodes, and the device of Comparative Example 1, in which an additive was added to an electrolyte so that the amount of the reactive moieties was about the same, the former recovered more CO₂ than the latter under the same conditions. This reveals that an electrode in which reactive moieties exhibiting redox by electrical response are integrated is more advantageous in the reaction efficiency of proton transfer.

Comparison of Examples 1 to 8 with Example 9 shows that by forming a COF or a MOF having a large specific surface area as a porous material containing reactive moieties performing proton transfer, the number of active sites for proton transfer can be increased, whereby the efficiency of CO₂ recovery can be further improved. In addition, comparison between Example 1 and Example 8, comparison between Example 2 and Example 5, comparison between Example 3 and Example 6, and comparison between Example 4 and Example 7 show that among the porous materials having the same reactive moieties, COF higher in electrical conductivity than MOF has a higher CO₂ recovery amount.

According to one or more embodiments and examples described above, a carbon dioxide absorption-release device is provided. The device includes a pair of electrodes each including a porous composite that includes an electro-conductive component and a porous material thereon, an aqueous electrolyte, and first and second electrolyte flow paths. The porous composite has reactive moieties that electrochemically perform proton transfer. In the first and second electrolyte flow paths, the aqueous electrolyte contacts one electrode and the other electrode, respectively. The device can efficiently absorb and release carbon dioxide, and can thus perform efficient gas separation of carbon dioxide.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Several embodiments according to the present invention are listed below:

1. A carbon dioxide absorption-release device comprising:
a pair of electrodes each including a porous composite, the porous composite comprising an electro-conductive component and a porous material on the electro-conductive component, the porous material comprising a reactive moiety for electrochemical proton transfer;
an aqueous electrolyte;
a first electrolyte flow path within which one of the pair of electrodes contacts the aqueous electrolyte; and
a second electrolyte flow path within which the other of the pair of electrodes contacts the aqueous electrolyte.

2. The carbon dioxide absorption-release device according to clause 1, capable of absorbing and releasing carbon dioxide by electrically changing pH of the aqueous electrolyte to change solubility of the carbon dioxide in the aqueous electrolyte.

3. The carbon dioxide absorption-release device according to clause 1 or 2, wherein the reactive moiety exhibits redox activity by electrical response.

4. The carbon dioxide absorption-release device according to clause 3, wherein the reactive moiety is capable of binding to proton(s) in a reduction state, and pH of the aqueous electrolyte increases when the reactive moiety accepts proton(s) from the aqueous electrolyte, thereby enhancing solubility of carbon dioxide.

5. The carbon dioxide absorption-release device according to clause 3 or 4, wherein the reactive moiety is capable of releasing proton(s) in an oxidization state, and pH of the aqueous electrolyte decreases when the reactive moiety donates proton(s) to the aqueous electrolyte, thereby lowering the solubility of carbon dioxide.

6. The carbon dioxide absorption-release device according to any one of clauses 1 to 5, capable of switching between a reduction current and an oxidation current between the pair of electrodes.

7. The carbon dioxide absorption-release device according to any one of clauses 1 to 5, capable of switching between a reduction potential and an oxidation potential between the pair of electrodes.

8. The carbon dioxide absorption-release device according to any one of clauses 3 to 7, wherein the reactive moiety includes at least one selected from the group consisting of quinone, catechol, furan, phenazine, phenanthrene, thiophene, pyridine, pyrrole, sulfide, disulfide, and fused heteroaromatic ring quinone.

9. The carbon dioxide absorption-release device according to any one of clauses 3 to 7, wherein the reactive moiety is a metal complex.

10. The carbon dioxide absorption-release device according to any one of clauses 3 to 7, wherein the reactive moiety is a part of an electroactive metal-organic framework.

11. The carbon dioxide absorption-release device according to any one of clauses 3 to 7, wherein the reactive moiety is a part of an electroactive covalent-organic framework.

12. The carbon dioxide absorption-release device according to any one of clauses 1 to 11, further comprising a membrane positioned between the pair of electrodes and separating the pair of electrodes.

13. The carbon dioxide absorption-release device according to any one of clauses 1 to 12, wherein each of the pair of electrodes further comprises a current collector onto which the porous composite is disposed and comprises least one selected from the group consisting of glassy carbon, a graphite sheet, carbon felt, carbon cloth, a carbon mesh, carbon paper, a carbon sheet with a gas diffusion layer, a copper plate, a copper sheet, a copper mesh, an aluminum plate, an aluminum sheet, an aluminum mesh, a nickel plate, a nickel sheet, a nickel mesh, a titanium plate, a titanium sheet, and a titanium mesh.

What is claimed is:

1. A carbon dioxide absorption-release device comprising:
a pair of electrodes each including a porous composite, the porous composite comprising an electro-conductive component and a porous material on the electro-conductive component, the porous material comprising a reactive moiety for electrochemical proton transfer;
an aqueous electrolyte;
a first electrolyte flow path within which one of the pair of electrodes contacts the aqueous electrolyte; and
a second electrolyte flow path within which the other of the pair of electrodes contacts the aqueous electrolyte.

2. The carbon dioxide absorption-release device according to claim 1, capable of absorbing and releasing carbon dioxide by electrically changing pH of the aqueous electrolyte to change solubility of the carbon dioxide in the aqueous electrolyte.

3. The carbon dioxide absorption-release device according to claim 1, wherein the reactive moiety exhibits redox activity by electrical response.

4. The carbon dioxide absorption-release device according to claim 3, wherein the reactive moiety is capable of binding to proton(s) in a reduction state, and pH of the aqueous electrolyte increases when the reactive moiety accepts proton(s) from the aqueous electrolyte, thereby enhancing solubility of carbon dioxide.

5. The carbon dioxide absorption-release device according to claim 4, wherein the reactive moiety is capable of releasing proton(s) in an oxidization state, and pH of the aqueous electrolyte decreases when the reactive moiety donates proton(s) to the aqueous electrolyte, thereby lowering the solubility of carbon dioxide.

6. The carbon dioxide absorption-release device according to claim 1, capable of switching between a reduction current and an oxidation current between the pair of electrodes.

7. The carbon dioxide absorption-release device according to claim 1, capable of switching between a reduction potential and an oxidation potential between the pair of electrodes.

8. The carbon dioxide absorption-release device according to claim 3, wherein the reactive moiety includes at least one selected from the group consisting of quinone, catechol, furan, phenazine, phenanthrene, thiophene, pyridine, pyrrole, sulfide, disulfide, and fused heteroaromatic ring quinone.

9. The carbon dioxide absorption-release device according to claim 3, wherein the reactive moiety is a metal complex.

10. The carbon dioxide absorption-release device according to claim 3, wherein the reactive moiety is a part of an electroactive metal-organic framework.

11. The carbon dioxide absorption-release device according to claim 3, wherein the reactive moiety is a part of an electroactive covalent-organic framework.

12. The carbon dioxide absorption-release device according to claim 1, further comprising a membrane positioned between the pair of electrodes and separating the pair of electrodes.

13. The carbon dioxide absorption-release device according to claim 1, wherein each of the pair of electrodes further comprises a current collector onto which the porous composite is disposed and comprises least one selected from the group consisting of glassy carbon, a graphite sheet, carbon felt, carbon cloth, a carbon mesh, carbon paper, a carbon sheet with a gas diffusion layer, a copper plate, a copper sheet, a copper mesh, an aluminum plate, an aluminum sheet, an aluminum mesh, a nickel plate, a nickel sheet, a nickel mesh, a titanium plate, a titanium sheet, and a titanium mesh.
